(19) United States
(12) Patent Application Publication
(10) Pub. No.: US 2020/0263090 A1
(43) Pub. Date: Aug. 20, 2020

(54) HIGH-DIELECTRIC-CONSTANT LIQUID CRYSTAL COMPOSITION USED FOR PHASE CONTROL OF ELECTROMAGNETIC WAVE SIGNAL

(71) Applicants: JNC CORPORATION, Tokyo (JP); JNC PETROCHEMICAL CORPORATION, Tokyo (JP)

(72) Inventors: Yoichi URYU, CHIBA (JP); Norio TAMURA, CHIBA (JP); Eiji OKABE, CHIBA (JP); Koki SAGO, CHIBA (JP); HITOSHI TOBATA, CHIBA (JP)

(73) Assignees: JNC CORPORATION, Tokyo (JP); JNC PETROCHEMICAL CORPORATION, Tokyo (JP)

(21) Appl. No.: 16/790,681

(22) Filed: Feb. 13, 2020

(30) Foreign Application Priority Data
Feb. 15, 2019 (JP) 2019-025139

(51) Int. Cl. C09K 19/34; C09K 19/12

(52) U.S. Cl. CPC C09K 19/3402; C09K 2019/0466; C09K 2219/11; C09K 19/12

(57) ABSTRACT

The disclosure provides a liquid crystal composition having favorable characteristics and excellent characteristic balance as a material used for an element used for phase control of an electromagnetic wave signal having a frequency of 1 MHz to 400 THz. A liquid crystal composition which is used for phase control of an electromagnetic wave signal having a frequency of 1 MHz to 400 THz, and which includes a compound selected from the group represented by Formula (1),

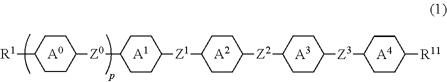

in Formula (1), the ring A⁰ to the ring A⁴ are each independently 1,4-phenylene and the like;
Z⁰ to Z³ are each independently a single bond or —CF₂O—, where —CF₂O— is one or less in Z⁰ to Z³;
p is 0 or 1; and
R¹ is alkyl having 1 to 12 carbon atoms and the like, and R¹¹ is —CN and the like.

### CROSS-REFERENCE TO RELATED APPLICATION

This application claims the priority benefit of Japan Application No. 2019-025139, filed on Feb. 15, 2019. The entirety of the above-mentioned patent application is hereby incorporated by reference herein and made a part of this specification.

### BACKGROUND

### Technical Field

The disclosure relates to an element used for phase control of an electromagnetic wave signal having a frequency of 1 MHz to 400 THz, and a liquid crystal composition used for the element. This composition has a nematic phase and positive dielectric constant anisotropy.

### Description of Related Art

Examples of elements used for phase control of an electromagnetic wave signal having a frequency of 1 MHz to 400 THz include a millimeter-wave band or microwave band antenna, an infrared laser element, and the like. Various types of these elements have been studied, but a type using a liquid crystal is attracting attention because this type is considered to generate fewer defects because it does not use mechanical movable parts.

In liquid crystal, orientation of molecules changes in response to an external bias electric field, and thus a dielectric constant changes. Using this property, it is possible to realize, for example, a microwave device that can electrically control transmission characteristics of a high-frequency transmission line from the outside. As such devices, a voltage-controlled millimeter-wave variable phase shifter in which a waveguide is filled with a nematic liquid crystal, a microwave-millimeter-wave wideband variable phase shifter using a nematic liquid crystal as a dielectric substrate for microstrip lines, and the like have been reported (Patent Documents 1 and 2).

It is desirable that an element used for such phase control of an electromagnetic wave signal have characteristics such as a wide usable temperature range, high gain, and low loss. Accordingly, as characteristics of a liquid crystal composition, the following characteristics are required: a high upper limit temperature of a nematic phase, a low lower limit temperature of a nematic phase, a low viscosity, high refractive index anisotropy in a frequency region used for phase control, high dielectric constant anisotropy, low dielectric loss, a high specific resistance in a driving frequency region, stability against heat, and the like.

Compositions of the related art are disclosed in Patent Documents 3 and 4 below.

In addition, since a liquid crystal material is a dielectric, polarization occurs. The mechanisms by which polarization occurs can be roughly divided into three: electronic polarization, ionic polarization, and orientation polarization. Since orientation polarization is polarization associated with orientation of liquid crystal molecules, an effect of loss of dielectric relaxation cannot be ignored, but noticeable loss disappears as a frequency becomes higher (for example, 1 MHz or more). As a result, in a high frequency region, only the electronic polarization and the ionic polarization are involved where a dielectric constant does not change due to loss. Since a dielectric constant is proportional to a refractive index (ε=n²) in a lossless dielectric, it can be said that a dielectric constant and a refractive index measured in the high frequency region are almost unchanged (Reference 1: Solid Properties-Lattice Vibration/Dielectrics (Shokabo Co., Ltd., written by SAKUDO Koutarou)).

### PATENT DOCUMENTS

[Patent Document 1] PCT International Publication No. WO2017/201515
[Patent Document 2] United States Patent Application, Publication No. 2018/0239213
[Patent Document 3] Japanese Patent Laid-Open No. 2004-285085
[Patent Document 4] Japanese Patent Laid-Open No. 2011-74074

### SUMMARY

The disclosure provides a liquid crystal composition which has significantly high dielectric constant anisotropy, and which can impart high gain characteristics to an element used for phase control of an electromagnetic wave signal having a frequency of 1 MHz to 400 THz.

The inventors of the disclosure have found that the above-described problems can be solved by a liquid crystal composition including a liquid crystal compound having a specific structure, and thus completed the disclosure.

The disclosure has the following configuration.

[1] A liquid crystal composition which is used for phase control of an electromagnetic wave signal having a frequency of 1 MHz to 400 THz, the liquid crystal composition including a compound selected from the group of compounds represented by Formula (1) as a liquid crystal compound.

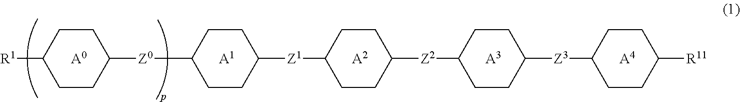

In Formula (1), the ring A⁰, the ring A¹, the ring A², the ring A³, and the ring A⁴ are each independently a group represented by any of Formulas (I) to (XIV);

Z⁰, Z¹, Z², and Z³ are each independently a single bond or —CF₂O—, where the number of —CF₂O— is one or less in Z⁰, Z¹, Z², and Z³;

p is 0 or 1;

R¹ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, where at least one —CH₂— in this R¹ may be replaced by —O—, —CO—, or —COO— such that O atoms are not directly bonded to each other; and

R¹¹ is R¹, —CF₃, —OCF₃, —CF₂H, —OCF₂H, —NCS, —SF₅, or —NO₂, where respective R¹'s may be the same as or different from each other in a case where R¹¹ is R¹.

In Formulas (VI) and (VII), R² is an alkyl having 1 to 5 carbon atoms, an alkoxy having 1 to 5 carbon atoms, an alkylthio having 1 to 5 carbon atoms, an alkenyl having 2 to 5 carbon atoms, or an alkenyloxy having 2 to 5 carbon atoms.

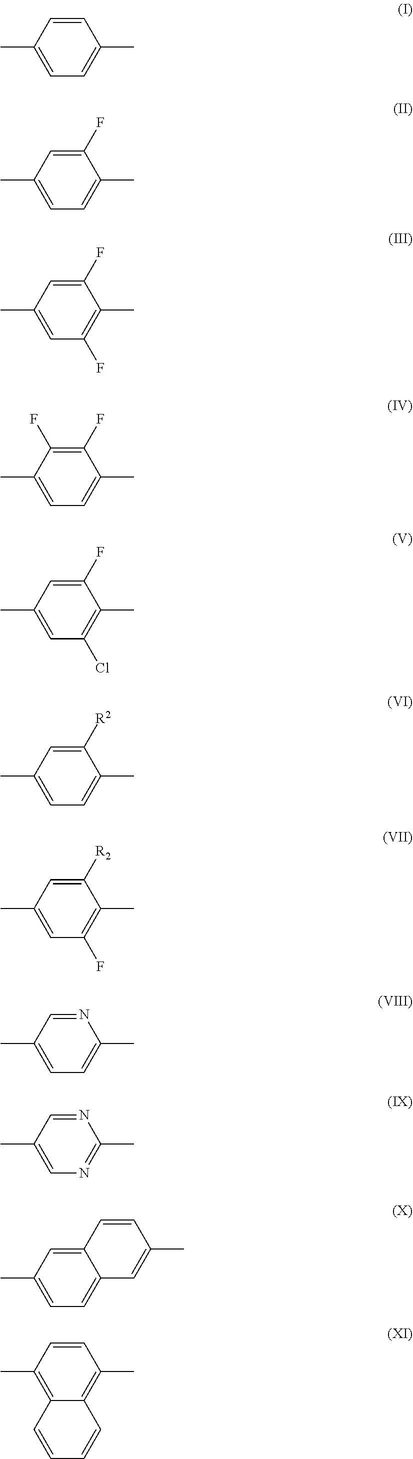

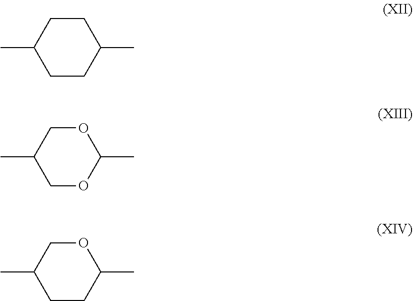

[2] The liquid crystal composition according to [1], further including at least one compound selected from Formulas (2) and (3) as the compound represented by Formula (1).

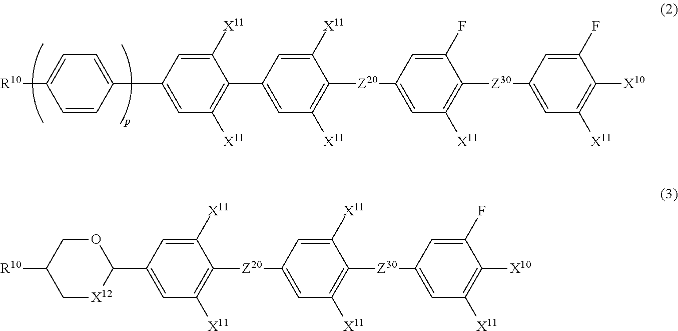

In Formulas (2) and (3),

one of Z²⁰ and Z³⁰ is a single bond, and the other is —CF₂O—;

p is 0 or 1;

R¹⁰ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, where at least one —CH₂— in this R¹⁰ may be replaced by —O—, —CO—, or —COO— such that O atoms are not directly bonded to each other;

X¹⁰ is —CN, —F, —Cl, —CF₃, —OCF₃, —CF₂H, —OCF₂H, —NCS, —SF₅, or —NO₂;

X¹¹'s are each independently H or F; and

X¹² is —CH₂— or —O—.

[3] The liquid crystal composition according to [2], further including at least one compound selected from the group of compounds represented by Formulas (2-1) to (2-41) and Formulas (3-1) to (3-13).

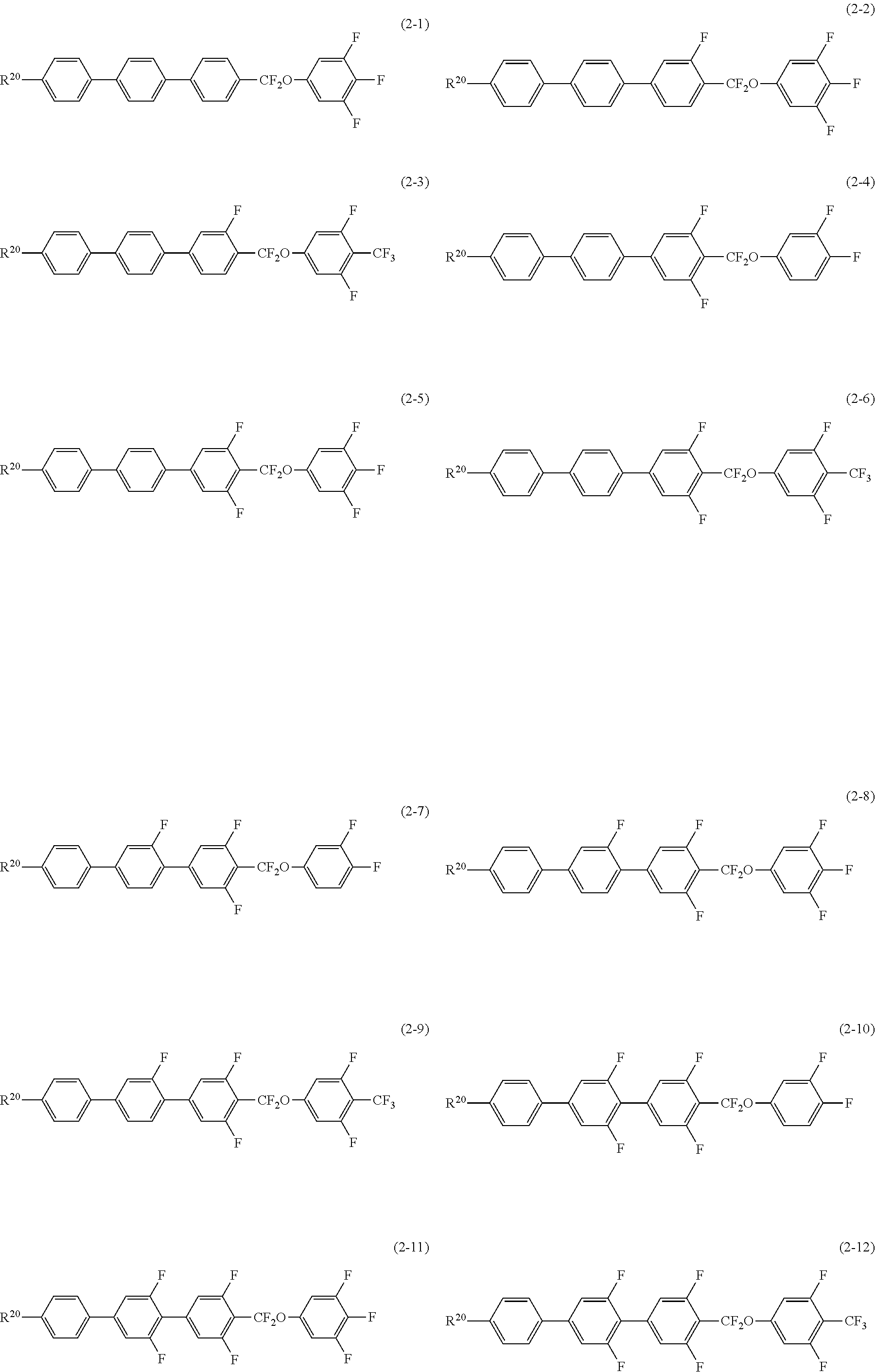

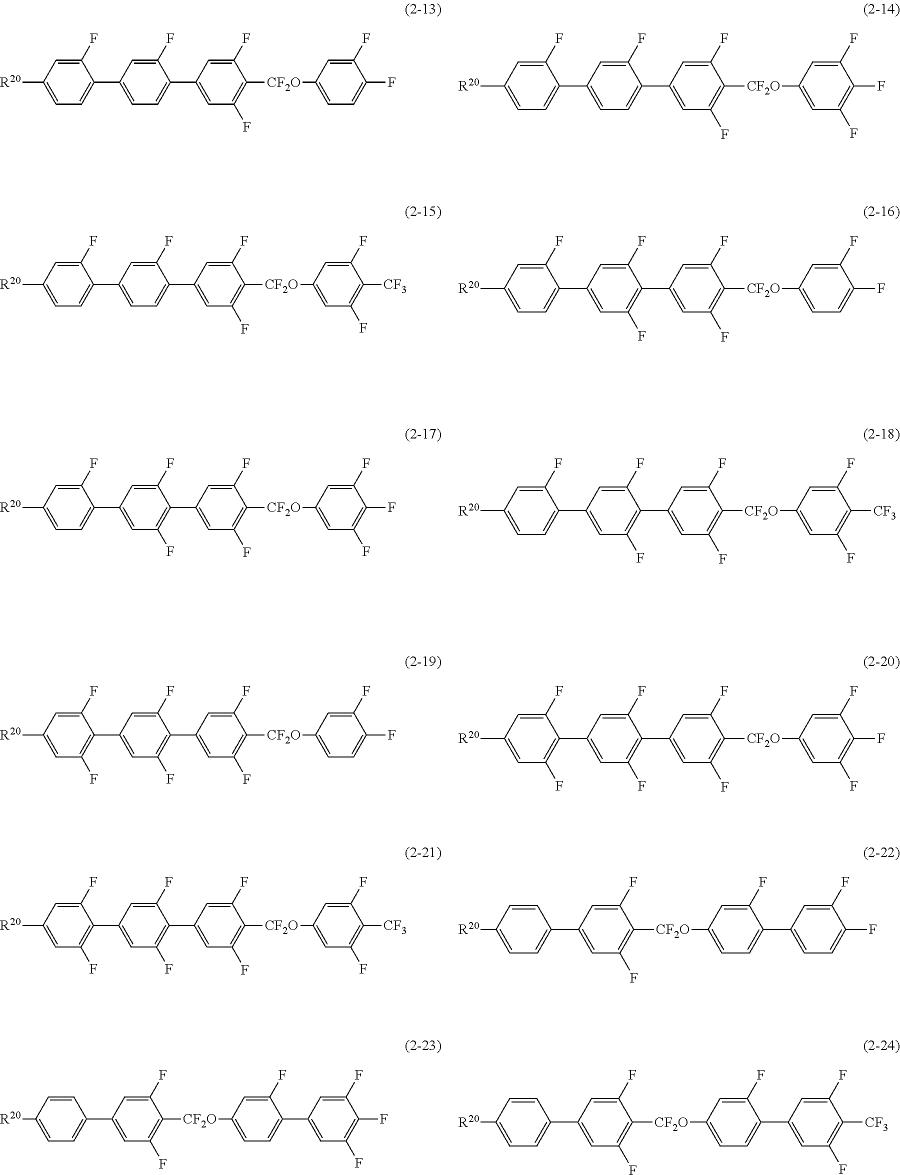

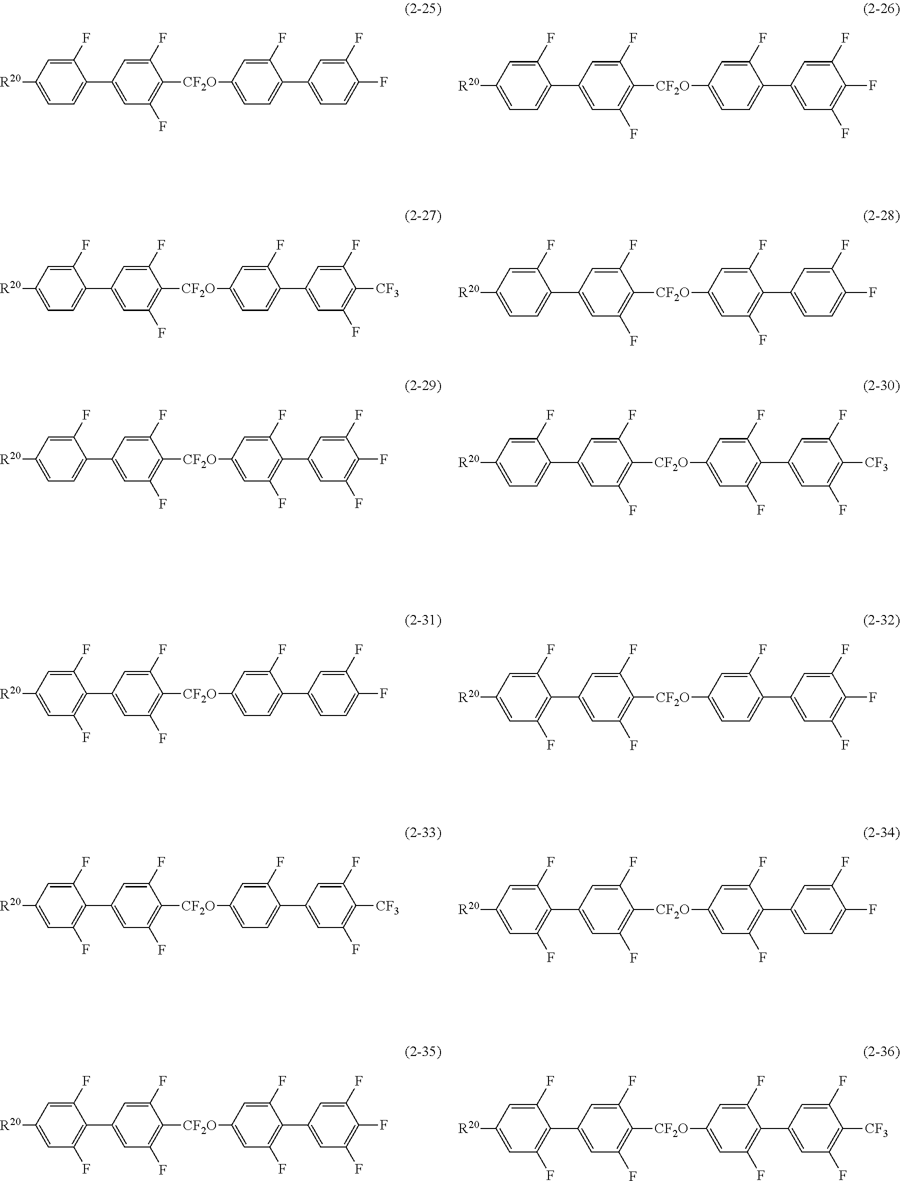

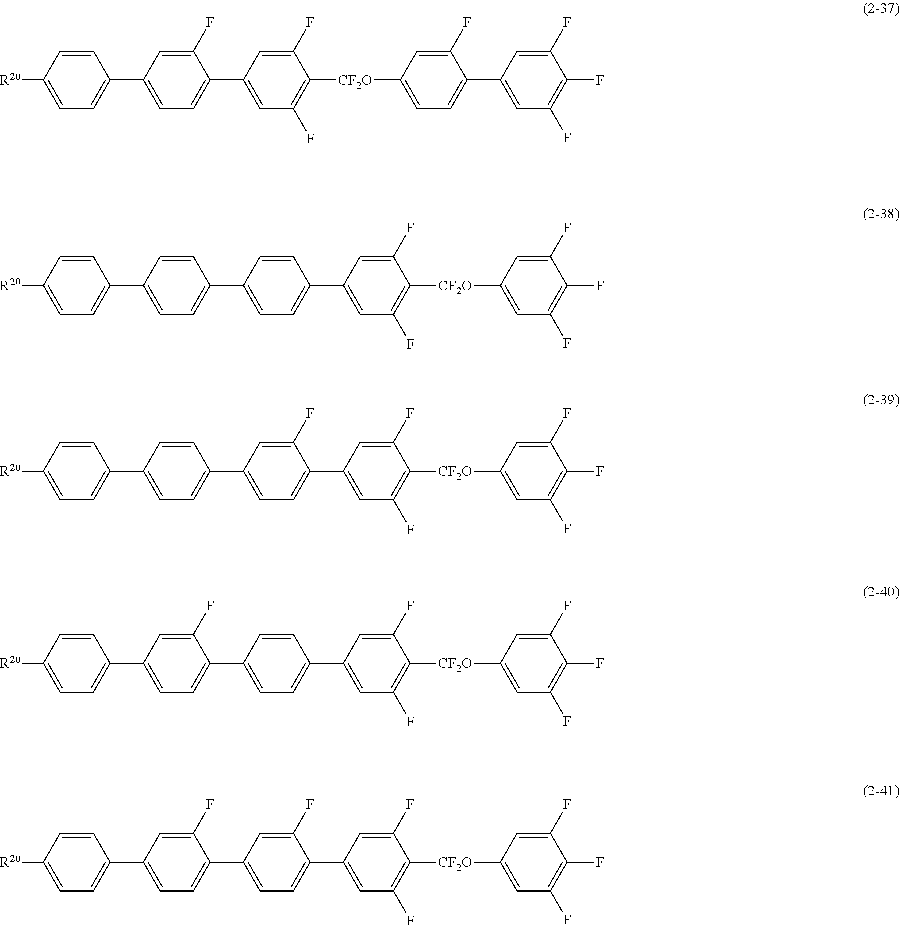

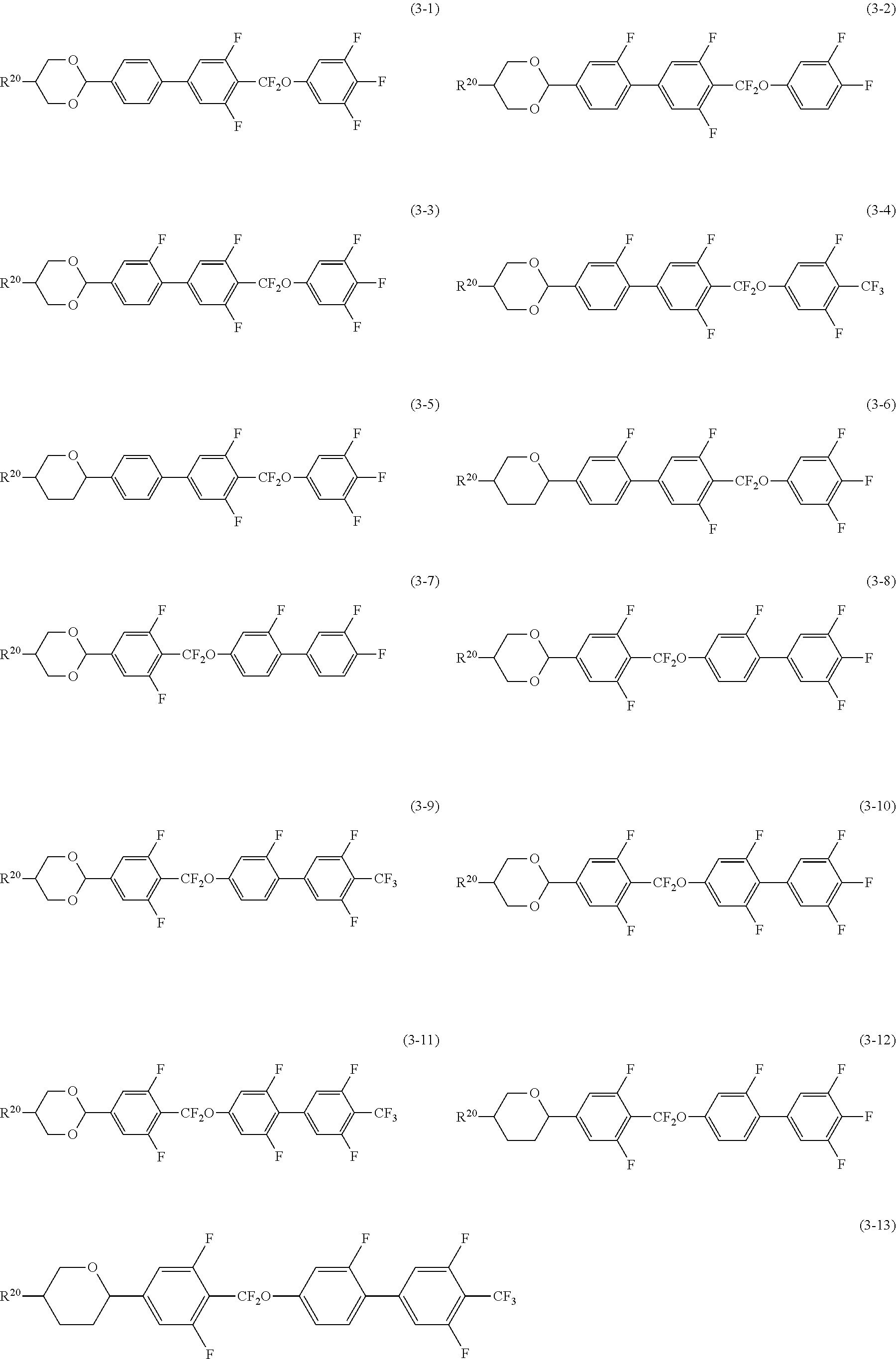

In Formulas (2-1) to (2-41) and Formulas (3-1) to (3-13),

R²⁰ is an alkyl having 1 to 8 carbon atoms, an alkoxy having 1 to 8 carbon atoms, an alkylthio having 1 to 8 carbon atoms, an alkenyl having 2 to 8 carbon atoms, or an alkenyloxy having 2 to 8 carbon atoms, where at least one —CH₂— in this R²⁰ may be replaced by —O— such that O atoms are not directly bonded to each other.

[4] The liquid crystal composition according to [2] or [3], further including at least one compound selected from Formula (4) as the compound represented by Formula (1).

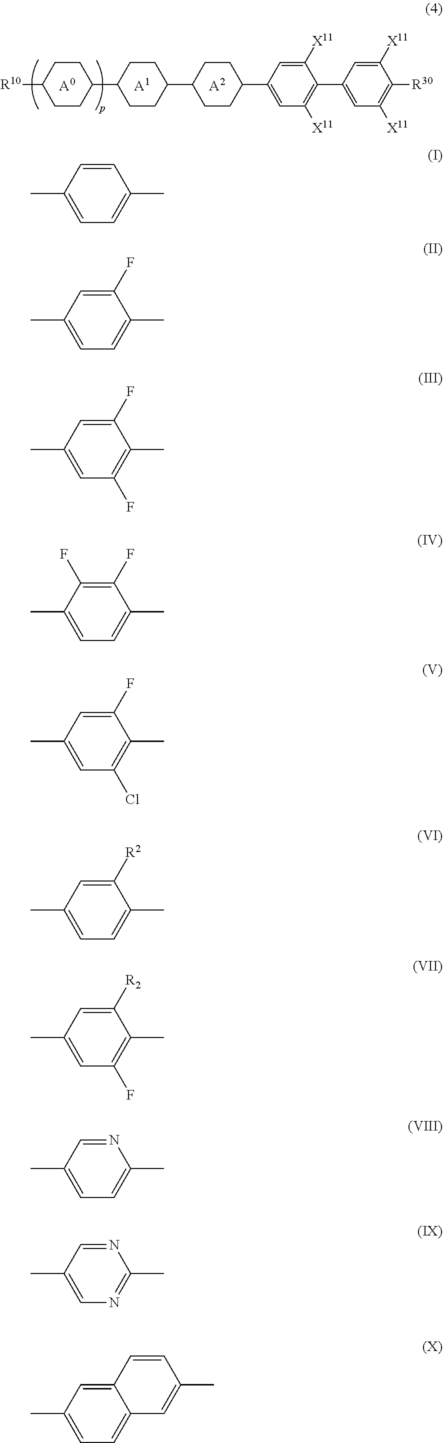

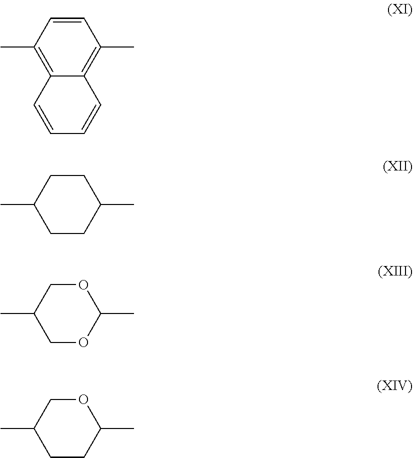

In Formula (4),

the ring A⁰, the ring A¹, and the ring A² are each independently a group represented by Formulas (I) to (XIV);

p is 0 or 1;

R¹⁰ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, where at least one —CH₂— in this R¹⁰ may be replaced by —O—, —CO—, or —COO— such that O atoms are not directly bonded to each other;

R³⁰ is R¹⁰, —CN, —F, —Cl, —CF₃, —OCF₃, —CF₂H, —OCF₂H, —NCS, —SF₅, or —NO₂, where respective R¹⁰'s may be the same as or different from each other in a case where R³⁰ is R¹⁰; and

X¹¹'s are each independently H or F.

In Formulas (VI) and (VII), R² is an alkyl having 1 to 5 carbon atoms, an alkoxy having 1 to 5 carbon atoms, an alkylthio having 1 to 5 carbon atoms, an alkenyl having 2 to 5 carbon atoms, or an alkenyloxy having 2 to 5 carbon atoms.

[5] The liquid crystal composition according to any one of [1] to [4], further including at least one selected from a light stabilizer and an antioxidant.

[6] The liquid crystal composition according to any one of [1] to [5], further including an optically active compound.

[7] The liquid crystal composition according to any one of [1] to [6], further including a radically polymerizable monomer.

[8] An element which is used for phase control of an electromagnetic wave signal having a frequency of 1 MHz to 400 THz, the element including the liquid crystal composition according to any one of [1] to [7].

Because the composition of the disclosure has high dielectric constant anisotropy at a frequency of 1 MHz to 400 THz, an element formed of the composition can greatly adjust a phase of an electromagnetic wave signal. In addition, the composition of the disclosure has low dielectric loss at a frequency of 1 MHz to 400 THz, has a wide temperature range of a nematic phase, and has high stability with respect to heat. Accordingly, an element formed of the composition of the disclosure has practically excellent characteristics.

### DESCRIPTION OF THE EMBODIMENTS

The liquid crystal composition of the disclosure may be simply called a “composition.” In an element of the disclosure, a phase in the “composition” may be not only nematic but may also be another liquid crystal phase or an isotropic liquid. In the case of using it as an element, a liquid crystal phase may be used, but a nematic phase is preferable. Examples of elements used for phase control of an electromagnetic wave signal having a frequency of 1 MHz to 400 THz include a millimeter wave band variable phase shifter, a light detection and ranging (LiDAR) element, and the like.

“Liquid crystal compound” refers to a compound having a liquid crystal phase such as a nematic phase or a smectic phase, or a compound not having a liquid crystal phase but useful as a component of the composition. This useful compound contains a six-membered ring such as 1,4-cyclohexylene or 1,4-phenylene and has a linear molecular structure. An optically active compound may be added to the composition. In the disclosure, this compound is classified as an additive even in a case where it is a liquid crystal compound.

An upper limit temperature of a nematic phase may be simply called an “upper limit temperature.” A lower limit temperature of a nematic phase may be simply called a “lower limit temperature.” The phrase “high specific resistance” means that the composition has a large specific resistance not only at room temperature but also at a high temperature in an initial stage, and has a large specific resistance not only at room temperature but also at a high temperature even after long-term use. Values measured by methods described in the Examples are used when describing characteristics such as refractive index anisotropy. “Ratio of a compound represented by Formula (1)” refers to a weight percentage (% by weight) based on a total weight of a liquid crystal compound. The same applies to a ratio of a compound represented by Formula (2). A proportion of additives mixed into the composition is a weight percentage (% by weight) based on a total weight of a liquid crystal compound.

The disclosure is characterized by using a composition containing a compound selected from the group of compounds represented by Formula (1).

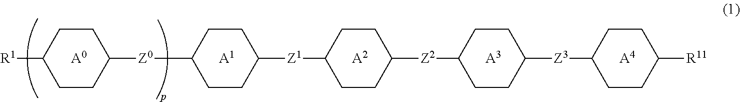

In Formula (1), the ring A⁰, the ring A¹, the ring A², the ring A³, and the ring A⁴ are each independently a group represented by any of Formulas (I) to (XIV);

Z⁰, Z¹, Z², and Z³ are each independently a single bond or —CF₂O—, where the number of —CF₂O— is one or less in Z⁰, Z¹, Z², and Z³;

p is 0 or 1;

R¹ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, where at least one —CH₂— in this R¹ may be replaced by —O—, —CO—, or —COO— such that O atoms are not directly bonded to each other; and

R¹¹ is R¹, —CN, —F, —Cl, —CF₃, —OCF₃, —CF₂H, —OCF₂H, —NCS, —SF₅, or —NO₂, where respective R¹'s may be the same as or different from each other in a case where R¹¹ is R¹.

In Formulas (VI) and (VII), R² is an alkyl having 1 to 5 carbon atoms, an alkoxy having 1 to 5 carbon atoms, an alkylthio having 1 to 5 carbon atoms, an alkenyl having 2 to 5 carbon atoms, or an alkenyloxy having 2 to 5 carbon atoms.

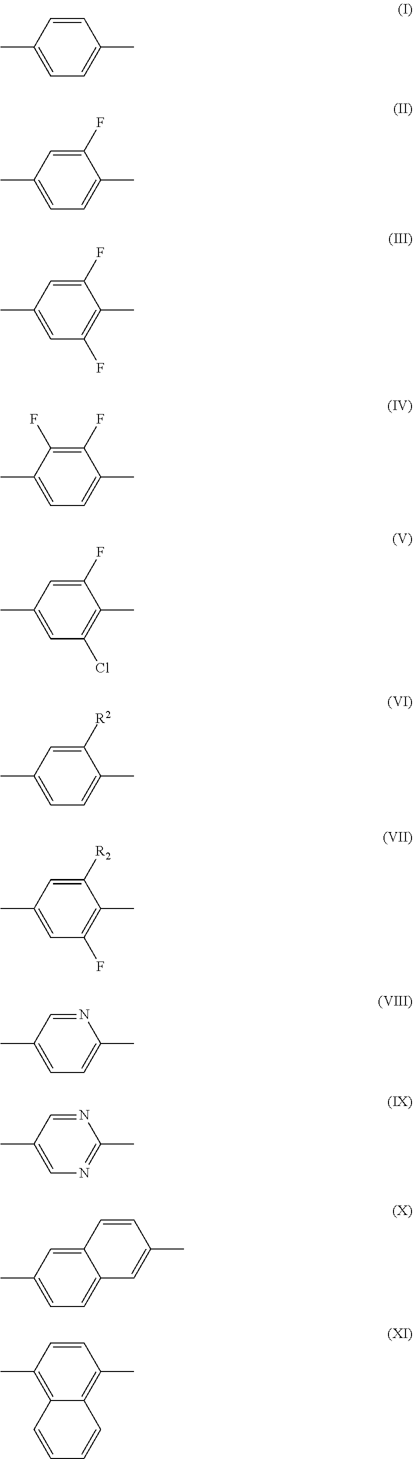

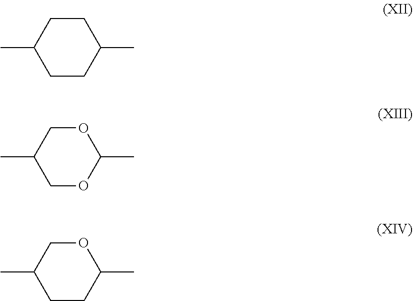

Such a composition has high dielectric constant anisotropy in a frequency region of an electromagnetic wave signal of 1 MHz to 400 THz. In this case, because dielectric constant anisotropy of the composition increases as a frequency decreases, the composition of the disclosure is preferably used for controlling an element related to an electromagnetic wave frequency of 1 MHz to 10 THz, or 1 MHz to 50 GHz.

The composition formed of a compound selected from the group represented by Formula (1) has high dielectric constant anisotropy as described above. In this case, it is preferable that one of Z⁰, Z¹, Z², and Z³ be —CF₂O— in the structure represented by Formula (1) to obtain a composition exhibiting high dielectric constant anisotropy. In addition, for the same purpose, among Z⁰, Z¹, Z², and Z³, it is more preferable that Z² or Z³ be —CF₂O—, and it is most preferable that Z³ be —CF₂O—.

It is possible to obtain a liquid crystal composition having high dielectric constant anisotropy by using the composition formed of a compound selected from the group represented by Formula (1) of the disclosure. However, other liquid crystal compositions having high dielectric constant anisotropy may be used for the purpose of the disclosure. In order to obtain such a composition, the easiest method is a method of adding another known liquid crystal compound to the composition formed of a compound selected from the group represented by Formula (1) of the disclosure. In this case, a mixing ratio of the composition formed of a compound selected from the group represented by Formula (1) of the disclosure is preferably 70% or more and is more preferably 80% or more with respect to a weight of the entire composition to increase dielectric constant anisotropy.

In order to increase dielectric constant anisotropy of the composition described above, it is preferable to select a group selected from Formulas (XIII) and (XIV), and it is particularly preferable to select a group from Formula (XIII) as the ring A⁰, the ring A¹, the ring A², the ring A³, and the ring A⁴ of Formula (1). In addition, R¹ is preferably an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms in which one or two or more —CH₂-'s are replaced by —O—, —CO—, or —COO—; and R¹ is particularly preferably an alkyl having 1 to 12 carbon atoms, an alkoxy having 1 to 12 carbon atoms, an alkenyl having 2 to 12 carbon atoms, or an alkenyloxy having 2 to 12 carbon atoms in which one or two or more —CH₂-'s are replaced by —O—.

It is also preferable to increase refractive index anisotropy of the composition to increase gain of an element in the frequency region of the electromagnetic wave signal of 1 MHz to 400 THz. For such a purpose, it is preferable that Z⁰, Z¹, Z², and Z³ be single bonds in the structure represented by Formula (1). Alternatively, Z³ is preferably —CF₂O—.

In order to increase refractive index anisotropy of the composition described above, it is preferable to select a group selected from Formulas (I), (II), (III), (VI), (VII), (X), and (XI), and it is more preferable to select a group from Formulas (I), (II), (VI), (VII), (X), and (XI) as the ring A⁰, the ring A¹, the ring A², the ring A³, and the ring A⁴ of Formula (1).

It is preferable to select a group selected from Formulas (VI), (VII), (X), and (XI), and it is more preferable to select a group from Formulas (VI), (VII), and (XI) as the ring A⁰, the ring A¹, the ring A², the ring A³, and the ring A⁴ of Formula (1) when reducing loss of the composition in order to maintain a wave intensity in a millimeter waveband variable phase shifting element.

As R^{H} in Formula (1), one selected from —F, —CF₃, —OCF₃, —CF₂H, —OCF₂H, and —SF₅ is preferable, and one selected from —F, —CF₃, and —OCF₃ is more preferable in order to obtain a liquid crystal composition having a lower limit temperature that is sufficiently low and high dielectric constant anisotropy. In addition, as R^{H}, one selected from —CN, —NCS, and —NO₂ is preferable, and one selected from —CN and —NCS is more preferable in order to obtain a liquid crystal composition having both high refractive index anisotropy and a high dielectric constant. Meanwhile, because these —CN and —NCS groups increase a lower limit temperature of the composition, an amount used is preferably 50% or less, and is more preferably 30% or less with respect to a total amount of the liquid crystal composition.

The compound group represented by Formula (1) is preferably a compound group represented by Formula (2) and Formula (3).

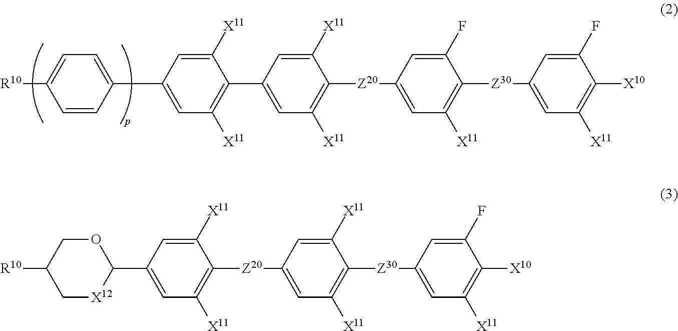

In Formulas (2) and (3),

one of Z²⁰ and Z³⁰ is a single bond and the other is —CF₂O—;

p is 0 or 1;

R¹⁰ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, where at least one —CH₂— in this R¹⁰ may be replaced by —O—, —CO—, or —COO— such that O atoms are not directly bonded to each other;

X¹⁰ is —CN, —F, —Cl, —CF₃, —OCF₃, —CF₂H, —OCF₂H, —NCS, —SF₅, or —NO₂;

X¹¹'s are each independently H or F; and

X¹² is —CH₂— or —O—.

Compound groups of Formulas (2-1) to (2-41) and Formulas (3-1) to (3-13) are particularly preferable as the compound group represented by (2) and (3).

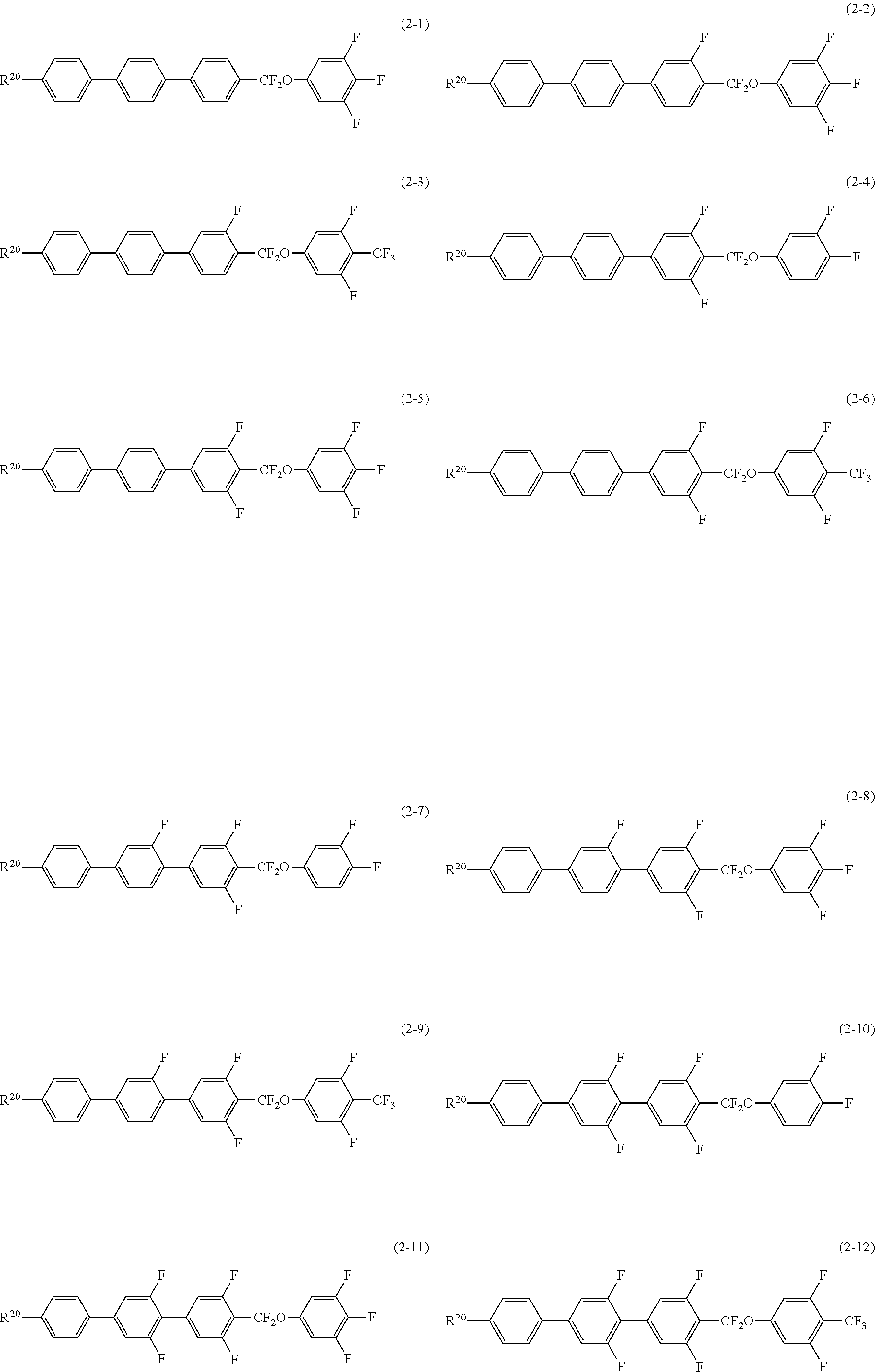

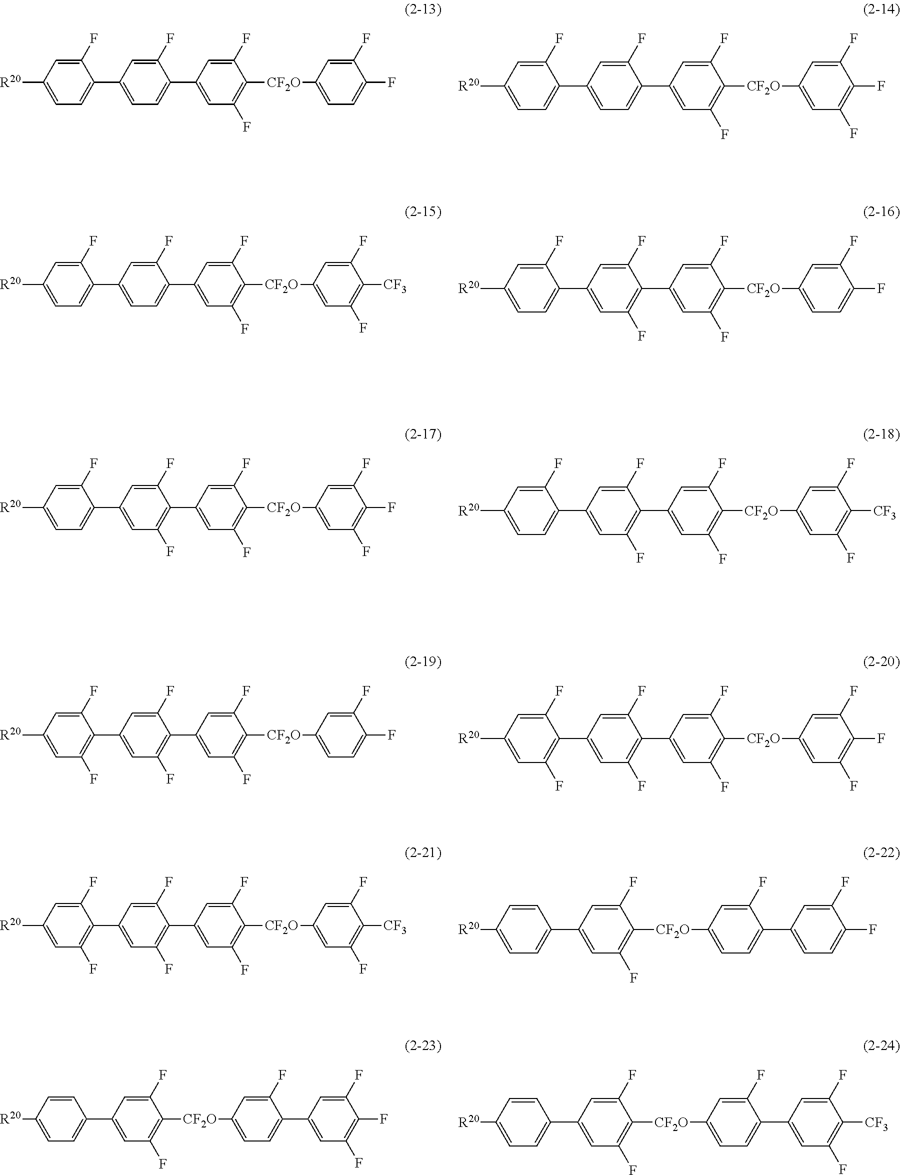

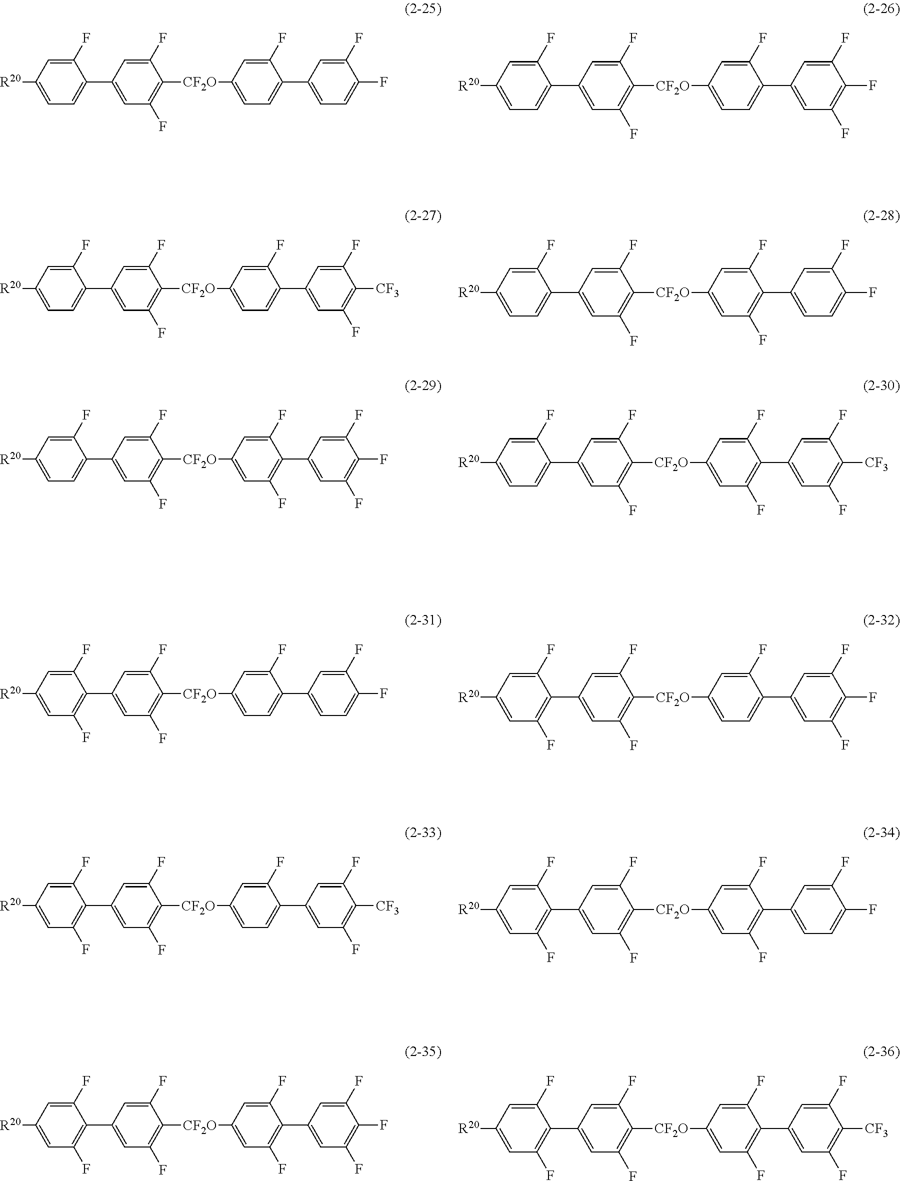

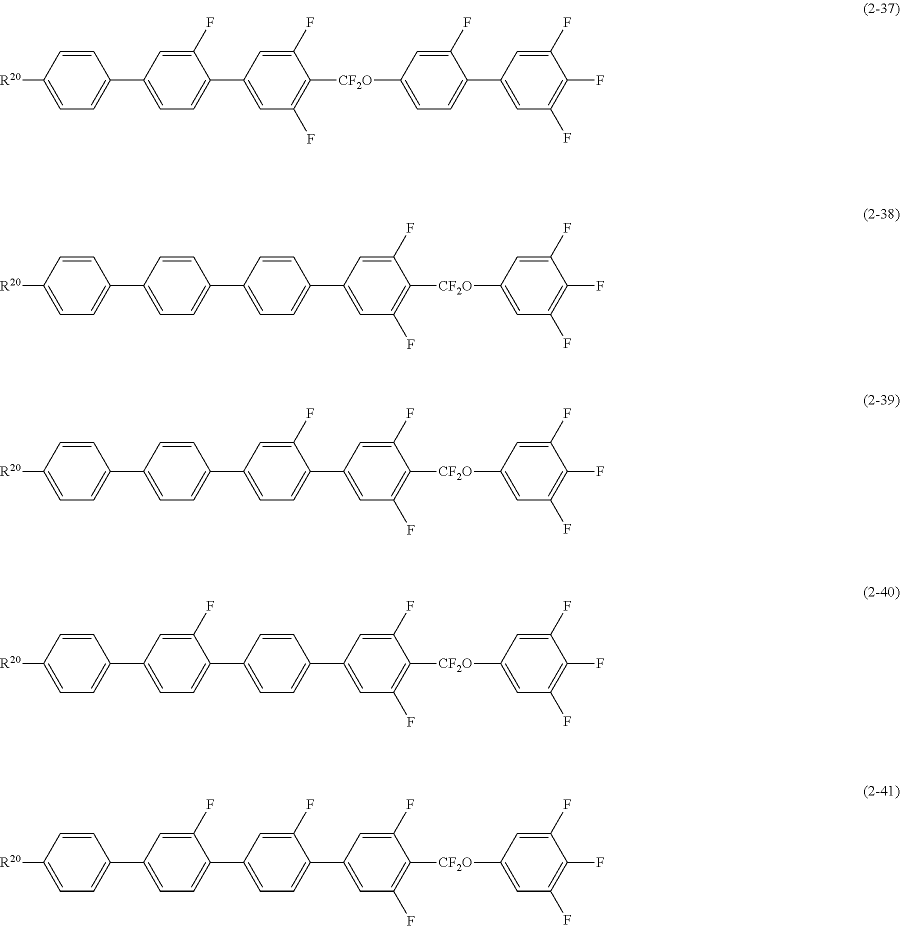

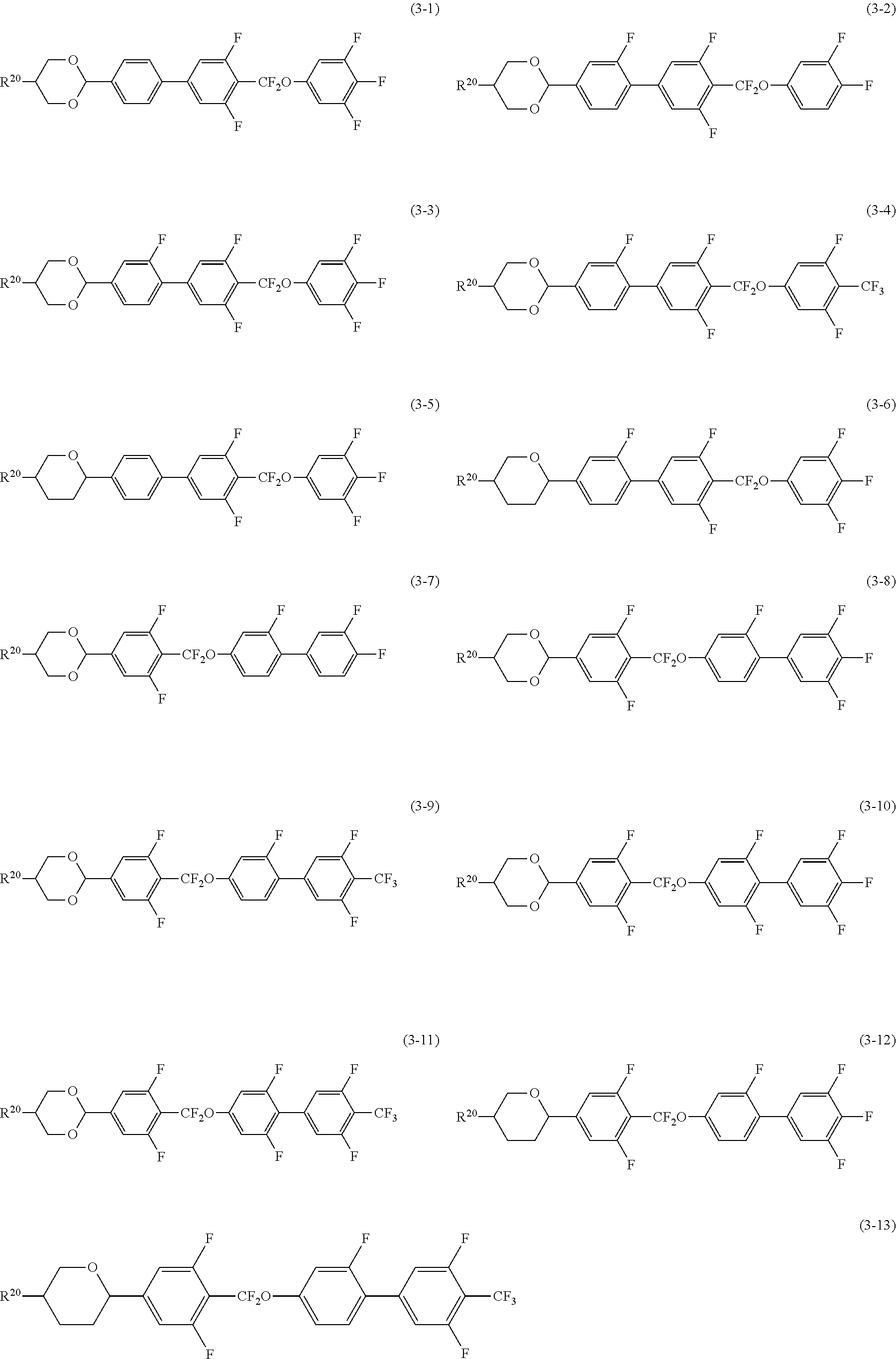

In Formulas (2-1) to (2-41) and Formulas (3-1) to (3-13),

R²⁰ is an alkyl having 1 to 8 carbon atoms, an alkoxy having 1 to 8 carbon atoms, an alkylthio having 1 to 8 carbon atoms, an alkenyl having 2 to 8 carbon atoms, or an alkenyloxy having 2 to 8 carbon atoms, where at least one —CH₂— in this R²⁰ may be replaced by —O— such that O atoms are not directly bonded to each other.

It is preferable to select methyl, ethyl, n-propyl, n-butyl, n-pentyl, n-hexyl, n-heptyl, or n-octyl as R²⁰ in the compounds of Formulas (2-1) to (2-41) and Formulas (3-1) to (3-13) in order to extend a liquid crystal temperature range or reduce a viscosity while maintaining dielectric constant anisotropy and refractive index anisotropy of the composition. In this case, it is more preferable to select ethyl, n-propyl, n-butyl, n-pentyl, or n-heptyl in order to further reduce a viscosity of the composition.

It is preferable to select an alkoxy as R²⁰ in the compounds of Formulas (2-1) to (2-41) and Formulas (3-1) to (3-13) in order to increase dielectric constant anisotropy and refractive index anisotropy while maintaining the liquid crystal temperature range of the composition. In this case, a preferred alkoxy is methoxy, ethoxy, n-propoxy, n-butoxy, n-pentyloxy, n-hexyloxy, or n-heptyloxy. A more preferred alkoxy is methoxy or ethoxy for reducing a viscosity.

As R²⁰, it is preferable to select an alkoxy in which one or two or more —CH₂-'s may be replaced by —O— such that O atoms are not directly bonded to each other in the compounds of Formulas (2-1) to (2-41) and Formulas (3-1) to (3-13) in order to further increase dielectric constant anisotropy of the composition. In this case, a preferred alkoxy is CH₃OCH₂CH₂O—, CH₃OCH₂CH₂CH₂O—, CH₃OCH₂CH₂CH₂CH₂O—, or CH₃OCH₂CH₂OCH₂CH₂O—.

As R²⁰, it is preferable to select an alkenyl such as vinyl, 1-propenyl, 2-propenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, or 5-hexenyl in the compounds of Formulas (2-1) to (2-41) and Formulas (3-1) to (3-13) to extend a temperature range of a nematic phase of the composition. In this case, it is more preferable to select vinyl, 1-propenyl, 3-butenyl, or 3-pentenyl to reduce a viscosity of the composition. A preferred steric arrangement of —CH═CH— in these alkenyls depends on a location of a double bond. Trans is preferable for an alkenyl such as 1-propenyl, 1-butenyl, 1-pentenyl, 1-hexenyl, 3-pentenyl, or 3-hexenyl to reduce a viscosity. Cis is preferable for an alkenyl such as 2-butenyl, 2-pentenyl, or 2-hexenyl. Among these alkenyls, a straight-chain alkenyl is preferable to a branched alkenyl.

In order to impart higher dielectric constant anisotropy to the composition, in the compounds of Formulas (2-1) to (2-41) and Formulas (3-1) to (3-13), it is preferable to select the structures of (2-7) to (2-36), (2-41), and (3-1) to (3-13), and it is more preferable to select the structures of (2-14), (2-15), (2-17), (2-18), (2-26), (2-27), (3-3), (3-4), (3-6), (3-8), (3-9), (3-12), and (3-13).

In order to impart higher refractive index anisotropy to the composition, in the compounds of Formulas (2-1) to (2-41) and Formulas (3-1) to (3-13), it is preferable to select the structures of (2-1) to (2-6) and (2-38) to (2-40), and it is more preferable to select the structures of (2-5) and (2-6).

The compound represented by Formula (2) has a relatively high transparent point, high dielectric constant anisotropy, and high refractive index anisotropy. A proportion of the compound represented by Formula (2) is preferably 20% by weight to 85% by weight, more preferably 20% by weight to 80% by weight, and particularly preferably 25% by weight to 75% by weight with respect to a total weight of an achiral component T.

The compound represented by Formula (3) has a high transparent point, relatively high dielectric constant anisotropy, and relatively high refractive index anisotropy. A proportion of the compound represented by Formula (3) is preferably 15% by weight to 80% by weight, more preferably 20% by weight to 80% by weight, and particularly preferably 25% by weight to 75% by weight with respect to a total weight of an achiral component T.

The composition of the disclosure is preferably formed of a compound selected from the group represented by Formulas (2) and (3), but the composition may further include at least one selected from Formula (4) in order to impart higher refractive index anisotropy, to extend a nematic temperature range, and to reduce a viscosity.

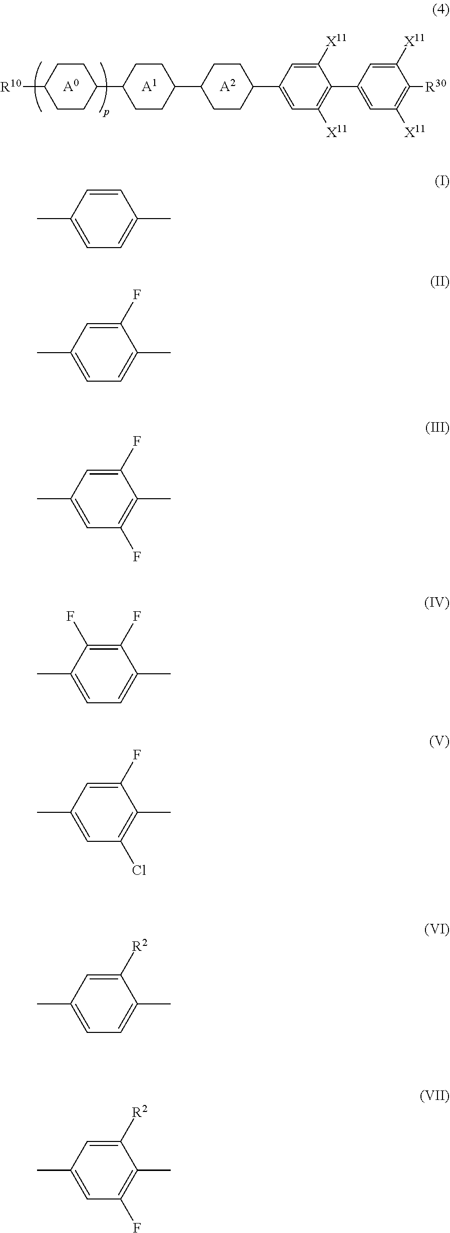

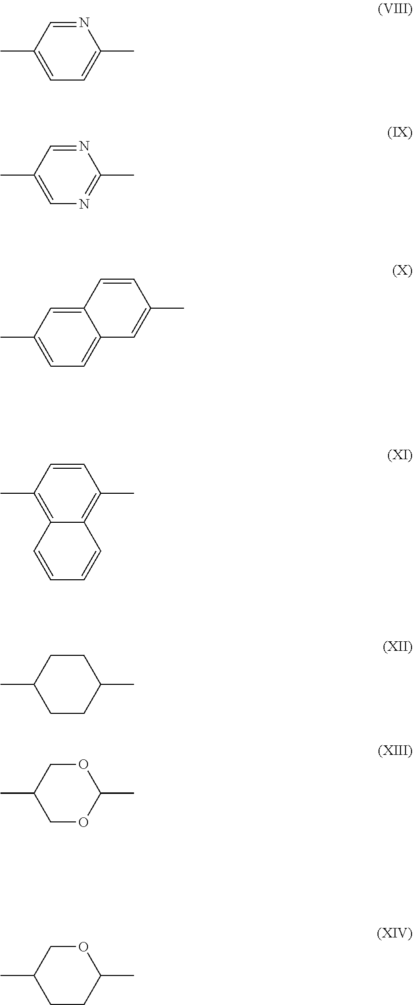

In Formula (4),

the ring A⁰, the ring A¹, and the ring A² are each independently a group represented by Formulas (I) to (XIV);

p is 0 or 1;

R¹⁰ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, where at least one —CH₂— in this R¹⁰ may be replaced by —O—, —CO—, or —COO— such that O atoms are not directly bonded to each other;

R³⁰ is R¹⁰, —CN, —F, —Cl, —CF₃, —OCF₃, —CF₂H, —OCF₂H, —NCS, —SF₅, or —NO₂, where respective R¹⁰'s may be the same as or different from each other in a case where R³⁰ is R¹⁰; and

X¹¹'s are each independently H or F.

In Formulas (VI) and (VII), R² is an alkyl having 1 to 5 carbon atoms, an alkoxy having 1 to 5 carbon atoms, an alkylthio having 1 to 5 carbon atoms, an alkenyl having 2 to 5 carbon atoms, or an alkenyloxy having 2 to 5 carbon atoms.

As the compound represented by Formula (4), specifically, it is possible to preferably use compounds represented by Formulas (4-1) to (4-14).

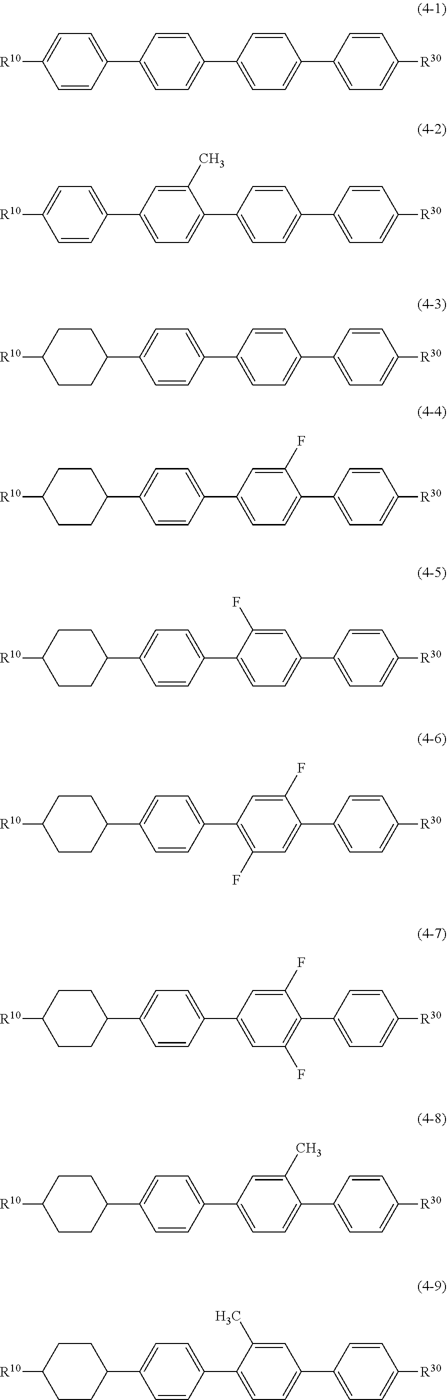

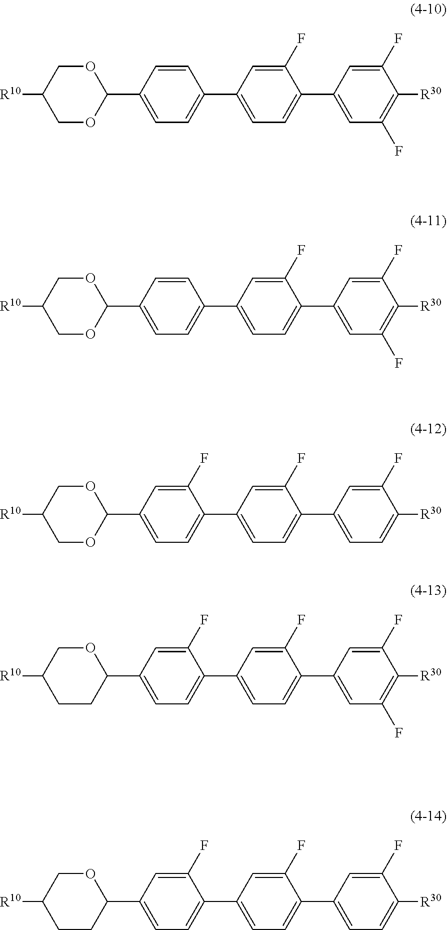

In Formulas (4-1) to (4-14), R¹⁰ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, where at least one —CH₂— in this R¹¹ may be replaced by —O—, —CO—, or —COO— such that O atoms are not directly bonded to each other; and R³⁰ is R¹⁰, —CN, —F, —Cl, —CF₃, —OCF₃, —CF₂H, —OCF₂H, —NCS, —SF₅, or —NO₂.

A proportion of the compound represented by Formula (4) is preferably 0% by weight to 30% by weight, more preferably 3% by weight to 25% by weight, and particularly preferably 5% by weight to 20% by weight with respect to a total weight of an achiral component T.

A light stabilizer, an antioxidant, or the like may be added to the composition of the disclosure to reduce deterioration in the liquid crystal composition due to heat and light. As such a light stabilizer and antioxidant, a compound represented by Formula (AI) is preferable because it has high effects and can prevent a reduction in the liquid crystal temperature range of the composition.

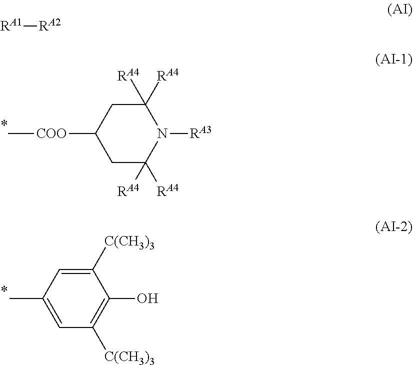

R^{A1} is a structure of Formula (AI-1) or (AI-2); R^{A2} is an organic group having 1 to 18 carbon atoms, where one to three hydrogens of this organic group may be replaced by the same structure of Formula (AI-1) or (AI-2) as R^{A1}; R^{A3} is hydrogen or an alkyl having 1 to 5 carbon atoms; R^{A4}'s are each independently an alkyl having 1 to 5 carbon atoms; and * indicates a linking position.

In the compound (AI), a compound having the structure of (AI-1) is a light stabilizer, and a compound having the structure of (AI-2) is an antioxidant. It is preferable to select a compound represented by Formula (AI-2-1) for an antioxidant. In Formula (AI-2-1), k is an integer of 1 to 12. In particular, a compound (AI-2-1) in which k is 1 has high volatility, and thus is effective in preventing a decrease in specific resistance due to heating in the air. A compound (AI-2-1) in which k is 7 has low volatility, and thus is effective in maintaining reliability not only at room temperature but also at a relatively high temperature even after a high-frequency antenna is used for a long time.

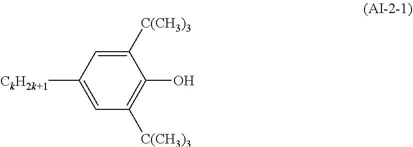

A preferable ratio of the light stabilizer is 100 ppm or more in order to obtain its effect, and is 5000 ppm or less so as not to lower the upper limit temperature or raise the lower limit temperature. A more preferable ratio is 100 ppm to 1000 ppm. In addition, a preferable ratio of the antioxidant is 50 ppm or more in order to obtain its effect, and is 600 ppm or less so as not to lower the upper limit temperature or raise the lower limit temperature. A more preferable ratio is 100 ppm to 300 ppm.

An optically active compound may be added to the composition of the disclosure. The above compound is mixed into the composition in order to induce a helical structure of a liquid crystal and to impart a twist angle. Examples of such compounds include compounds (C-1) to (C-5). A preferable ratio of the optically active compound is 5% or less. A more preferable ratio is within a range of 0.01% to 2%.

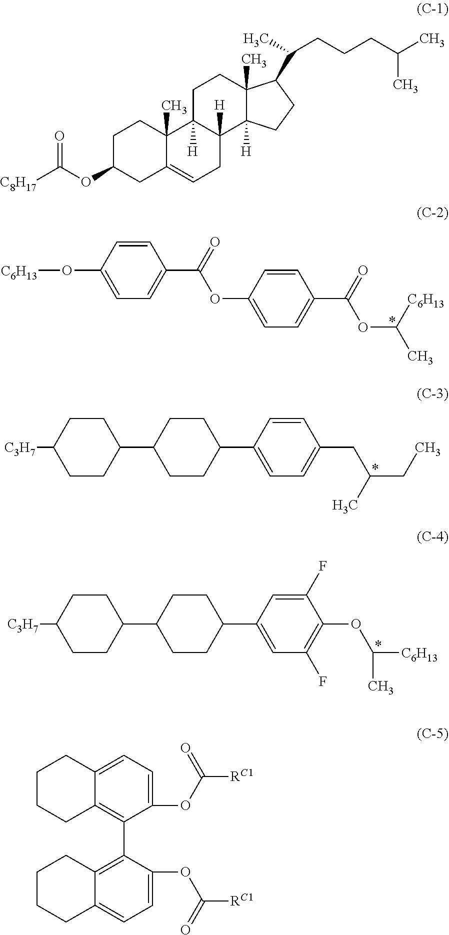

In Formulas (C-5), R^{C1}'s are each independently a hydrocarbon having up to 30 carbon atoms and having a ring structure. In Formulas (C-2) to (C-4), * represents an asymmetric carbon.

The composition of the disclosure may include dyes such as an azo-based, carotenoid-based, flavonoid-based, quinone-based, or porphyrin-based dye to improve anisotropy at a frequency of 1 MHz to 400 THz.

The composition of the disclosure may include a polymerizable compound to improve its characteristics. Examples of cases in which characteristics of an antenna element have been improved using a polymer-dispersed liquid crystal for such a purpose include a case of IEEE

Transactions on Fundamentals and Materials, vol. 137, no. 6, pp. 356 (2017), and the like. Also in the case of the composition of the disclosure, a polymerizable compound may be added to the composition in order to achieve such improvement. As such a polymerizable compound, a radically polymerizable compound is preferable to maintain electrical characteristics of an element, and it is preferable to select a (meth)acryl group from the viewpoint of reactivity during polymerization and solubility in liquid crystal.

Preferable examples of such polymerizable compounds include a (meth)acryl derivative having a skeleton similar to a liquid crystal. These compounds do not significantly lower a phase transition point of the composition, and therefore they are preferably used in a case where the composition is used while being oriented in one direction. Preferable examples of such compounds include compounds represented by Formulas (M-1) to (M-3).

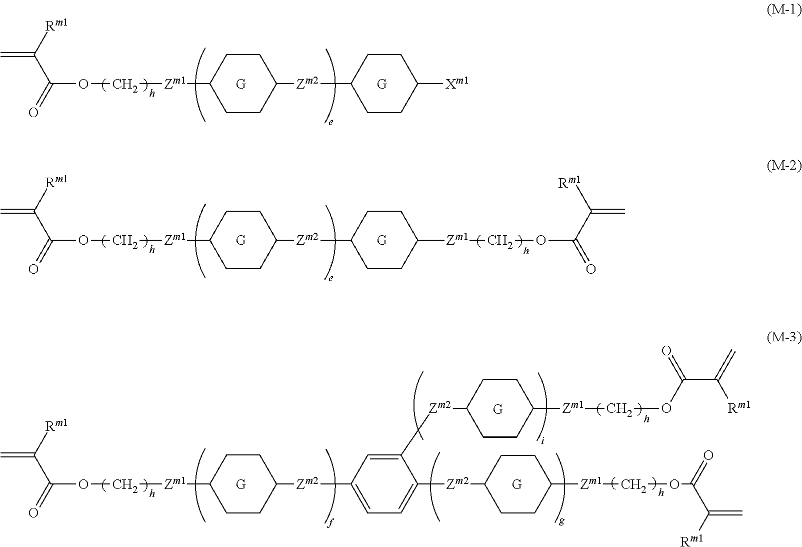

In Formulas (M-1), (M-2), and (M-3), the rings G are each independently 1,4-cyclohexylene, 1,4-phenylene, 1,3-dioxane-2,5-diyl, naphthalene-2,6-diyl, or fluorene-2,7-diyl, where, at least one hydrogen may be replaced by fluorine, trifluoromethyl, an alkyl having 1 to 12 carbon atoms, an alkoxy having 1 to 12 carbon atoms, an alkoxycarbonyl having 1 to 12 carbon atoms, or an alkanoyl having 1 to 12 carbon atoms; Z^{m1}'s are each independently a single bond, —OCH₂—, —COO—, or —OCOO—; Z^{m2} is a single bond, —O—, —OCH₂—, or —COO—; X^{m1} is hydrogen, fluorine, chlorine, trifluoromethyl, trifluoromethoxy, cyano, an alkyl having 1 to 20 carbon atoms, an alkenyl having 2 to 20 carbon atoms, an alkoxy having 1 to 20 carbon atoms, or an alkoxycarbonyl having 1 to 20 carbon atoms; e is an integer of 1 to 4; f and g are each independently an integer of 0 to 3, where a sum off and g is 1 to 4; i is 0 or 1; h's are each independently an integer of 0 to 20; and R^{m1}'s are each independently hydrogen or —CH₃.

More preferable examples of polymerizable compounds include a (meth)acryl derivative not having a skeleton similar to a liquid crystal. These compounds are preferably used when lowering a driving voltage of an element. Preferable examples of such compounds include compounds represented by Formula (M-4).

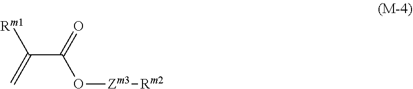

In Formula (M-4), Z^{m3} is a single bond or an alkylene having 1 to 80 carbon atoms, where in this alkylene, at least one hydrogen may be replaced by an alkyl having 1 to 20 carbon atoms, fluorine, or a structure of Formula (7), and at least one —CH₂— may be replaced by —O—, —CO—, —COO—, or —OCO—, —NH—, or —N(R^{m3})—, and in a case where it is replaced by a plurality of —O-'s, these —O-'s are not adjacent to each other; R^{m3} is an alkyl having 1 to 12 carbon atoms, where at least one —CH₂—CH₂— may be replaced by —CH═CH—, or —C≡C—; and

R^{m2} is an alkyl having 1 to 20 carbons, where in this alkyl, at least one hydrogen may be replaced by fluorine, and at least one —CH₂— may be replaced by —O—, —CO—, —COO—, or —OCO—, and in a case where it is replaced by a plurality of —O-'s, these —O-'s are not adjacent to each other, and where at least one —CH₂— may be replaced by divalent groups generated by removing two hydrogens from a carbocyclic saturated aliphatic compound, a heterocyclic saturated aliphatic compound, a carbocyclic unsaturated aliphatic compound, or a heterocyclic unsaturated aliphatic compound, and in these divalent groups, the carbon number is 5 to 35, and at least one hydrogen may be replaced by an alkyl having 1 to 12 carbon atoms, and in this alkyl, one —CH₂— may be replaced by —O—, —CO—, —COO—, or —OCO—; and R^{m1} is hydrogen or —CH₃.

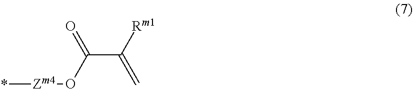

In Formula (7), Z^{m4} is an alkylene having 1 to 12 carbon atoms, R^{m1} is hydrogen or —CH₃, and * indicates a linking position.

Preferable examples of the compounds represented by Formulas (M-1) to (M-4) include compounds of Formulas (M-2-1) to (M-2-6), Formulas (M-3-1), and Formulas (M-4-1) to (M-4-11).

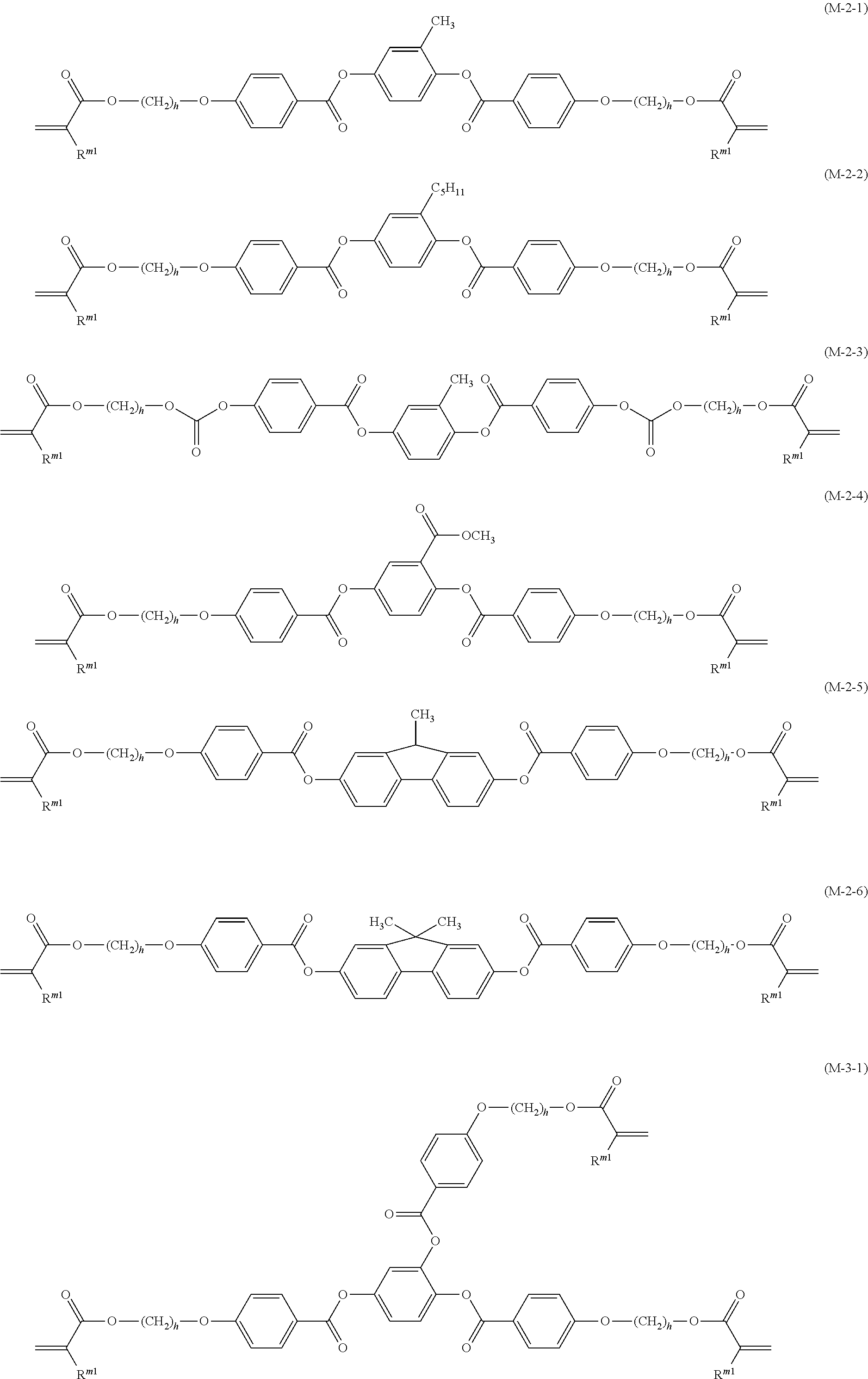

In Formulas (M-2-1) to (M-2-6), R^{m1}'s are each independently hydrogen or —CH₃, and h's are each independently an integer of 1 to 20.

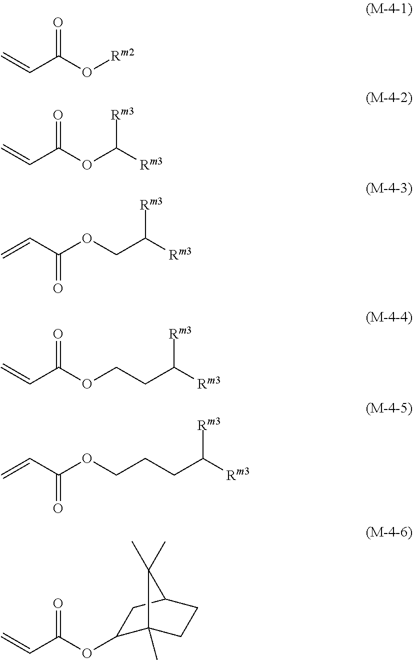

In Formulas (M-4-1) to (M-4-6), R^{m2} is an alkyl having 5 to 20 carbon atoms, where in this alkyl, at least one —CH₂— may be replaced by —O—, —CO—, —COO—, or —OCO—; and R^{m3}'s are each independently an alkyl having 3 to 10 carbon atoms, where in this alkyl, at least one —CH₂— may be replaced by —O—, —CO—, —COO—, or —OCO—.

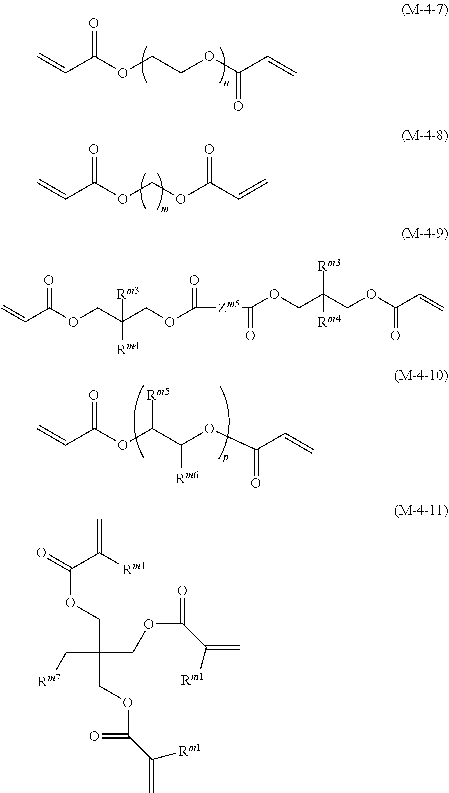

In Formula (M-4-7), n is an integer of 1 to 10.

In Formula (M-4-8), m is an integer of 2 to 20.

In Formula (M-4-9), R^{m3}'s are each independently an alkyl having 1 to 5 carbon atoms; and R^{m4}'s are each independently an alkyl having 1 to 20 carbon atoms, where in this alkyl at least one —CH₂— may be replaced by —O—, —CO—, —COO—, or —OCO—, and R^{m3} and R^{m4} in the same formula may be the same as or different from each other; and

Z^{m5} is an alkylene having 10 to 30 carbon atoms, where in this alkylene, at least one —CH₂— may be replaced by —O—, —CO—, —COO—, or —OCO—, and an alkylene includes an alkylene having a branched alkyl.

In Formula (M-4-10), p is an integer of 3 to 10; and R^{m5} and R^{m6} are hydrogen or —CH₃, where one of them is —CH₃.

In Formula (M-4-11), R^{m7} is OH, (meth)acryloyl, or a structure in which a residue other than R^{m7} in Formula (M-4-11) is bonded via —O—; and R^{m1}'s are each independently hydrogen or —CH₃.

When the liquid crystal composition of the disclosure is applied to an element, an orientation film made of a material such as polyimide is used to orient the liquid crystal composition. Meanwhile, an orientation control agent is added to a liquid crystal to orient the liquid crystal composition. As such an orientation control agent, compounds described in WO2017-057162, WO2012-104008, WO2016-129490, and the like are preferably used.

Finally, use applications of the composition will be described. Most compositions have a lower limit temperature of −10° C. or less, an upper limit temperature of 70° C. or more, and a refractive index anisotropy (measured with visible light) of 0.16 to 0.30.

Dielectric constants of a dielectric such as a liquid crystal change according to frequency and temperature. Accordingly, frequency dependence of these dielectric constants is called a dielectric property of a dielectric. When an AC electric field is applied to a liquid crystal, an internal electric dipole cannot follow changes of electric field as a frequency f increases, and as a result, a dielectric constant ε′ decreases, an electrical conductivity σ′ increases at the same time, and a dielectric loss ε″ shows a peak. This phenomenon is dielectric relaxation.

In a microwave-millimeter wave region, a method of mounting a device or sample is completely different depending on a frequency region to be measured. Up to 10 GHz, a measurement system is often built around a network analyzer using open-ended coaxial cells as probes because electromagnetic field analysis is easy, and a complex dielectric constant spectrum (a dielectric relaxation spectrum) of the sample is obtained by sweeping a frequency. At tens of GHz or more, it is necessary to use a waveguide instead of a coaxial cable. Boundary conditions when an electromagnetic wave is incident on a sample need to be properly determined to calculate a dielectric constant, and more precise processing is required as a wavelength becomes shorter. In a low frequency region, a cell is formed as a capacitor, a sample is inserted into the cell, and a dielectric constant is obtained from a change in capacitance.

### EXAMPLES

The disclosure will be described in more detail according to examples. The disclosure is not limited by these examples. Examples were performed at room temperature (25° C.) unless otherwise specified.

<Measurement Method>

Measurement and verification were performed by the following method. Measurement methods not described in the present specification were performed according to JEITA ED-2521B unless otherwise specified.

<DSC Measurement>

Measurement was performed using a differential scanning calorimeter (Diamond DSC, Perkin Elmer). A transition temperature was shown by writing a temperature in Celsius between notations indicating a phase. In the notations indicating a phase, C is a crystal layer, N is a nematic phase, S is a smectic phase, and I is an isotropic liquid. In the notations indicating a phase, the description of a phase in parentheses indicates a monotropic liquid crystal phase.

<Upper Limit Temperature of Nematic Phase>

In the examples, “NI” is an “upper limit temperature.”

The upper limit temperature is a measurement value of a temperature at which a part of a sample changes from a nematic phase to an isotropic liquid when the sample is placed on a hot plate of a melting point apparatus equipped with a polarized-light microscope and heated at a rate of 1° C./min.

<Lower Limit Temperature of Nematic Phase>

In the examples, “Tc” is a “lower limit temperature.”

The lower limit temperature is determined by putting a sample having a nematic phase in a glass bottle and storing it in a freezer at 0° C., −10° C., −20° C., −30° C., and −40° C. for 10 days, and observing a phase. For example, when the sample remained in a nematic phase at −20° C. and but changed to a crystalline or smectic phase at −30° C., Tc was notated as <−20° C.

<Refractive Index Anisotropy in Visible Light>

In the examples, refractive index anisotropy is denoted as “Δn.”

Δn is measured by an Abbe refractometer in which a polarizing plate is attached to an eyepiece.

A surface of a main prism is rubbed in one direction, and then a sample is added dropwise onto the main prism, and measurement is performed using a refractive index in which a polarization direction is perpendicular to a rubbing direction as n⊥, and using a refractive index in which a polarization direction is parallel to the rubbing direction as n∥. An is calculated by Δn=n∥−n⊥. At this time, a light having a wavelength of 589 nm is used, and a measurement temperature is 25° C.

<Dielectric Constant Anisotropy at 1 kHz>

A value of dielectric constant anisotropy is calculated from the equation: Δε=ε∥−ε⊥. Dielectric constants (ε∥ and ε⊥) are measured as follows.

(A) Measurement of dielectric constant (ε∥): A solution of octadecyltriethoxysilane (0.16 mL) in ethanol (20 mL) is applied to a well-cleaned glass substrate. The glass substrate is rotated with a spinner and then is heated at 150° C. for 1 hour. A sample is placed in a VA element in which a distance between two glass substrates is 4 μm, and this element is sealed with an adhesive that is cured by ultraviolet light. A sine wave (0.5 V, 1 kHz) is applied to the element, and after 2 seconds, a dielectric constant (ε∥) in a major axis direction of liquid crystal molecules is measured.

(B) Measurement of dielectric constant (ε⊥): A polyimide solution is applied to a well-cleaned glass substrate. The glass substrate is fired, and then rubbing treatment is performed on the obtained orientation film. A sample was injected into a TN element in which a distance between two glass substrates is 9 μm and a twist angle is 80 degrees. A sine wave (0.5 V, 1 kHz) is applied to the element, and after 2 seconds, a dielectric constant (ε⊥) in a minor axis direction of liquid crystal molecules is measured.

<Voltage Holding Ratio (VHR)>

A cell used for the measurement has the following structure. That is, an ITO electrode and a rubbed polyimide orientation film were disposed in this order on each substrate.

The two substrates were bonded together so that a surface of the orientation film was on the inner side, and an angle of the rubbing direction between the upper and lower substrates became 80 degrees. A distance (cell gap) between the two glass substrates was 5 μm. The liquid crystal composition was put in this cell and was sealed with an adhesive that is cured by ultraviolet light. This TN element was charged by applying a pulse voltage (60 microseconds at 5 V) thereto. A decaying voltage was measured for 16.7 milliseconds with a high-speed voltmeter, and an area A between a voltage curve and a horizontal axis in a unit cycle was obtained. An area B was an area when there was no decaying. A voltage holding ratio was expressed as a percentage of the area A to the area B.

<Refractive Index Anisotropy and Dielectric Loss at 50 GHz>

Measurement was performed according to a method disclosed in Applied Optics, Vol. 44, No. 7, p 1150 (2005). For refractive index anisotropy, a V-band variable short-circuit waveguide to which a window member was attached was filled with a liquid crystal, and was kept in a static magnetic field of 0.3 T for 3 minutes. A microwave of 50 GHz was input to the waveguide, and an amplitude ratio of a reflected wave to an incident wave was measured. The measurement was performed while changing a direction of the static magnetic field and a tube length of the short-circuit device, and refractive indices (ne, no) and loss parameters (αe, αo) were determined. The refractive index anisotropy (Δn) was calculated from ne−no.

Using complex dielectric constants (ε′, ε″), calculation was performed as dielectric loss (tan δ)=ε″/ε′. The complex dielectric constants were calculated using the calculated refractive indices and loss parameters described above, and the following relational expression. c is a speed of light in vacuum. A larger value was described because anisotropy also appears in the case of dielectric loss.

ε′=n²−κ²

ε″=2nκ

α=2ωc/κ

<Bulk Viscosity>

For bulk viscosity, an E-type rotating viscometer manufactured by TOKYO KEIKI INC. is used. A measurement temperature is 20° C.

<Liquid Crystal Compound>

A structure of the liquid crystal compound is represented according to the notation in Table 1. Divalent groups of a six-membered ring in Table 1 are trans-arranged unless otherwise specified. The number in parentheses written after a symbolized compound in the liquid crystal composition indicates a chemical formula to which the compound belongs. The symbol (-) means other liquid crystal compounds. A ratio of the liquid crystal compound is a percentage by weight based on a weight of the liquid crystal composition not containing additives. These compounds were synthesized in the same manner as methods described in International Patent Publication No. 96/11897, International Patent Publication No. 2013/080724, and the like.

TABLE 1
Notation of compounds using symbols
R—(A₁)—Z₁— . . . —Zₙ—(Aₙ)—R′

| 1) Left terminal group R— | Symbol |
|---|---|
| C [symbol] H [symbol] — | n- |
| C [symbol] H [symbol] O— | nO— |
| CₘH [symbol] OCₙH₂ₙ— | mOn— |
| CH₂═CH— | V— |
| CₙH₂ₙ₊ [symbol] —CH═CH— | nV— |
| CH₂═CH—C [symbol] H [symbol] — | Vn— |
| C [symbol] H [symbol] —CH═CH—C [symbol] H [symbol] — | mVn— |
| CF₂═CH— | VFF— |
| CF₂═CH—C [symbol] H [symbol] — | VFFn— |
| C [symbol] H [symbol] —CH(C [symbol] H [symbol] )—C [symbol] H [symbol] — | m(p)n- |
| 2) Right terminal group —R′ | |
| —CₙH₂ [symbol] | -n |
| —OCₙH₂ₙ₊₁ | —On |
| —CH═CH₂ | —V |
| —CH═CH—C [symbol] H [symbol] | —Vn |
| —CₙH₂ₙ—CH═CH₂ | —nV |
| —C [symbol] H [symbol] —CH═CH—C [symbol] H [symbol] | —nVm |
| —CH═CF₂ | —VFF |
| —COOCH₃ | —EMe |
| —F | —F |
| —Cl | —CL |
| —OCF₃ | —OCF3 |
| —CF₃ | —CF3 |
| —CN | —C |
| —OCH═CH—CF₃H | —OVCF2H |
| —OCH═CH—CF₃ | —OVCF3 |
| 3) Linking group -Zn- | |
| —C [symbol] H [symbol] — | 2 |
| —COO— | E |
| —CH═CH— | V |
| —C≡C— | T |
| —CF₃O— | X |
| —CH₂O— | 10 |
| 4) Ring structure -An- | |
| 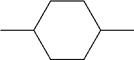 | H |
| 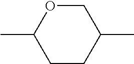 | Dh |
| 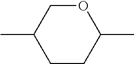 | dh |
| 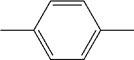 | B |
| 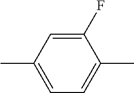 | B(F) |
| 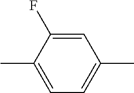 | B(2F) |
| 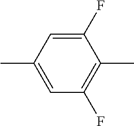 | B(F,F) |
| 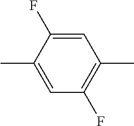 | B(2F,5F) |
| 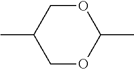 | G |
| 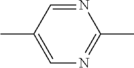 | Py |
| 5) Notation Examples | |
| Example 1 3-BB(F)TB-2 | |
| 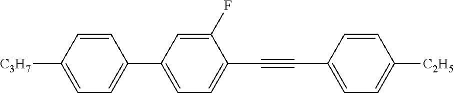 | |
| Example 2 3-BB(F)B(F,F)-F | |
| 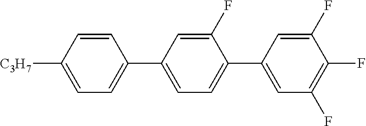 | |
| Example 3 4-BB(F)B(F,F)XB(F,F)-F | |
| 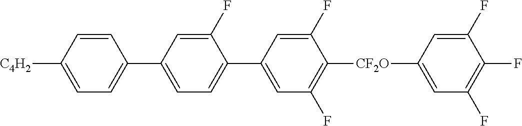 | |

[symbol]

indicates data missing or illegible when filed

<Liquid Crystal Composition>

### Example 1

Preparation and Physical Properties of Liquid Crystal Composition 1

| | |
|---|---|
| 5-B(F)B(F,F)B(F,F)XB(F,F)-F(2-17) | 3.00% |
| 4-B(F)B(F,F)B(F,F)XB(F,F)-F(2-17) | 3.00% |
| 6-B(F)B(F,F)B(F,F)XB(F,F)-CF3(2-18) | 4.00% |
| 5-B(F)B(F,F)B(F,F)XB(F,F)-CF3(2-18) | 4.00% |
| 4-B(F)B(F,F)B(F,F)XB(F,F)-CF3(2-18) | 4.00% |
| 3-B(F)B(F,F)B(F,F)XB(F,F)-CF3(2-18) | 4.00% |
| 2(1)2-B(F)B(F,F)B(F,F)XB(F,F)-CF3(2-18) | 10.00% |
| 5-BB(F,F)B(F,F)XB(F,F)-CF3 (2-12) | 4.00% |
| 4-BB(F,F)B(F,F)XB(F,F)-CF3 (2-12) | 4.00% |
| 5-GB(F)B(F,F)XB(F,F)-F(3-3) | 5.00% |
| 4-GB(F)B(F,F)XB(F,F)-F(3-3) | 5.00% |
| 3-GB(F)B(F,F)XB(F,F)-F(3-3) | 5.00% |
| 4-GB(F,F)XB(F)B(F,F)-F(3-8) | 15.00% |
| 3-GB(F,F)XB(F)B(F,F)-F(3-8) | 15.00% |
| 2-GB(F,F)XB(F)B(F,F)-F(3-8) | 15.00% |

NI = 80.0° C.;
Tc < −20° C.;
Δn = 0.157; and
Δ∈ = 111

Values of refractive index anisotropy and dielectric loss at 50 GHz of the liquid crystal composition 1 were as follows.

Refractive index anisotropy: 0.15

Dielectric loss: 0.015

### Example 2

Preparation and Physical Properties of Liquid Crystal Composition 2

| | |
|---|---|
| 5-B(F)B(F,F)B(F,F)XB(F,F)-F(2-17) | 2.275% |
| 4-B(F)B(F,F)B(F,F)XB(F,F)-F(2-17) | 2.275% |
| 6-B(F)B(F,F)B(F,F)XB(F,F)-CF3(2-18) | 3.76% |
| 5-B(F)B(F,F)B(F,F)XB(F,F)-CF3(2-18) | 3.76% |
| 4-B(F)B(F,F)B(F,F)XB(F,F)-CF3(2-18) | 3.76% |
| 3-B(F)B(F,F)B(F,F)XB(F,F)-CF3(2-18) | 3.77% |
| 5-B(F)B(F,F)XB(F)B(F,F)-F(2-26) | 3.00% |
| 4-B(F)B(F,F)XB(F)B(F,F)-F(2-26) | 3.00% |
| 3-B(F)B(F,F)XB(F)B(F,F)-F(2-26) | 3.00% |
| 5-GB(F)B(F,F)XB(F,F)-F(3-3) | 9.00% |
| 4-GB(F)B(F,F)XB(F,F)-F(3-3) | 9.00% |
| 3-GB(F)B(F,F)XB(F,F)-F(3-3) | 8.40% |
| 5-GB(F,F)XB(F)B(F,F)-F(3-8) | 15.00% |
| 4-GB(F,F)XB(F)B(F,F)-F(3-8) | 15.00% |
| 3-GB(F,F)XB(F)B(F,F)-F(3-8) | 15.00% |

NI = 87.6° C.;
Tc < −20° C.;
Δn = 0.161; and
Δ∈ = 113

Values of refractive index anisotropy and dielectric loss at 50 GHz of the liquid crystal composition 2 were as follows.

Refractive index anisotropy: 0.14

Dielectric loss: 0.023

### Example 3

Preparation and Physical Properties of Liquid Crystal Composition 3

| | |
|---|---|
| 5-BB(F)B(F,F)XB(F,F)-F(2-8) | 6.00% |
| 4-BB(F)B(F,F)XB(F,F)-F(2-8) | 6.00% |
| 3-BB(F)B(F,F)XB(F,F)-F(2-8) | 6.00% |
| 5-B(F)B(F,F)B(F,F)XB(F,F)-F(2-17) | 2.00% |
| 4-B(F)B(F,F)B(F,F)XB(F,F)-F(2-17) | 2.00% |
| 4-B(F)B(F,F)B(F,F)XB(F,F)-CF3(2-18) | 2.00% |
| 3-B(F)B(F,F)B(F,F)XB(F,F)-CF3(2-18) | 2.00% |
| 3-BB(F,F)XB(F)B(F,F)-F(2-23) | 11.00% |
| 3-B(F)B(F,F)XB(F)B(F)-F(2-25) | 7.00% |
| 5-B(F)B(F,F)XB(F)B(F,F)-F(2-26) | 6.00% |
| 4-B(F)B(F,F)XB(F)B(F,F)-F(2-26) | 6.00% |
| 3-B(F)B(F,F)XB(F)B(F,F)-F(2-26) | 6.00% |
| 5-BB(F)B(F,F)XB(F)B(F,F)-F(2-37) | 5.00% |
| 5-GB(F)B(F,F)XB(F,F)-F(3-3) | 4.00% |
| 4-GB(F)B(F,F)XB(F,F)-F(3-3) | 4.00% |
| 3-GB(F)B(F,F)XB(F,F)-F(3-3) | 4.00% |
| 5-GB(F,F)XB(F)B(F,F)-F(3-8) | 7.00% |
| 4-GB(F,F)XB(F)B(F,F)-F(3-8) | 7.00% |
| 3-GB(F,F)XB(F)B(F,F)-F(3-8) | 7.00% |

NI = 104.6° C.;
Tc < −20° C.;
Δn = 0.195; and
Δ∈ = 151

Values of refractive index anisotropy and dielectric loss at 50 GHz of the liquid crystal composition 3 were as follows.

Refractive index anisotropy: 0.20

Dielectric loss: 0.016

### Example 4

Preparation and Physical Properties of Liquid Crystal Composition 4

| | |
|---|---|
| 3-BB(F)B(F,F)XB(F)-F(2-7) | 8.00% |
| 5-BB(F)B(F,F)XB(F,F)-F(2-8) | 9.00% |
| 4-BB(F)B(F,F)XB(F,F)-F(2-8) | 7.00% |
| 3-BB(F)B(F,F)XB(F,F)-F(2-8) | 8.00% |
| 5-B(F)B(F,F)B(F,F)XB(F,F)-F(2-17) | 2.00% |
| 4-B(F)B(F,F)B(F,F)XB(F,F)-F(2-17) | 2.00% |
| 3-BB(F,F)XB(F)B(F,F)-F(2-23) | 10.00% |
| 5-B(F)B(F,F)XB(F)B(F,F)-F(2-26) | 7.00% |
| 4-B(F)B(F,F)XB(F)B(F,F)-F(2-26) | 7.00% |
| 3-B(F)B(F,F)XB(F)B(F,F)-F(2-26) | 7.00% |
| 5-GB(F)B(F,F)XB(F,F)-F(3-3) | 7.00% |
| 4-GB(F)B(F,F)XB(F,F)-F(3-3) | 7.00% |
| 3-GB(F)B(F,F)XB(F,F)-F(3-3) | 7.00% |
| 5-GB(F,F)XB(F)B(F,F)-F(3-8) | 3.00% |
| 4-GB(F,F)XB(F)B(F,F)-F(3-8) | 4.00% |
| 3-GB(F,F)XB(F)B(F,F)-F(3-8) | 5.00% |

NI = 101.7° C.;
Tc < −20° C.;
Δn = 0.195; and
Δ∈ = 138

Values of refractive index anisotropy and dielectric loss at 50 GHz of the liquid crystal composition 4 were as follows.

Refractive index anisotropy: 0.19

Dielectric loss: 0.015

### Example 5

Preparation and Physical Properties of Liquid Crystal Composition 5

| | |
|---|---|
| 3-BB(F)B(F,F)XB(F)-F(2-7) | 8.00% |
| 5-BB(F)B(F,F)XB(F,F)-F(2-8) | 9.00% |
| 4-BB(F)B(F,F)XB(F,F)-F(2-8) | 7.00% |
| 3-BB(F)B(F,F)XB(F,F)-F(2-8) | 8.00% |
| 4-B(F)B(F,F)B(F,F)XB(F,F)-CF3(2-18) | 2.00% |
| 3-B(F)B(F,F)B(F,F)XB(F,F)-CF3(2-18) | 2.00% |
| 3-BB(F,F)XB(F)B(F,F)-F(2-23) | 10.00% |
| 5-B(F)B(F,F)XB(F)B(F,F)-F(2-26) | 7.00% |
| 4-B(F)B(F,F)XB(F)B(F,F)-F(2-26) | 7.00% |
| 3-B(F)B(F,F)XB(F)B(F,F)-F(2-26) | 7.00% |
| 5-GB(F)B(F,F)XB(F,F)-F(3-3) | 7.00% |
| 4-GB(F)B(F,F)XB(F,F)-F(3-3) | 7.00% |
| 3-GB(F)B(F,F)XB(F,F)-F(3-3) | 7.00% |
| 5-GB(F,F)XB(F)B(F,F)-F(3-8) | 3.00% |
| 4-GB(F,F)XB(F)B(F,F)-F(3-8) | 4.00% |
| 3-GB(F,F)XB(F)B(F,F)-F(3-8) | 5.00% |

NI = 101.2° C.;
Tc < −20° C.;
Δn = 0.195; and
Δ∈ = 148

Values of refractive index anisotropy and dielectric loss at 50 GHz of the liquid crystal composition 5 were as follows.

Refractive index anisotropy: 0.20

Dielectric loss: 0.015

### Example 6

Preparation and Physical Properties of Liquid Crystal Composition 6

| | |
|---|---|
| 3-BB(F)B(F,F)XB(F)-F(2-7) | 7.00% |
| 5-BB(F)B(F,F)XB(F,F)-F(2-8) | 9.00% |
| 4-BB(F)B(F,F)XB(F,F)-F(2-8) | 7.00% |
| 3-BB(F)B(F,F)XB(F,F)-F(2-8) | 8.00% |
| 3-BB(F,F)XB(F)B(F,F)-F(2-23) | 10.00% |
| 5-B(F)B(F,F)XB(F)B(F,F)-F(2-26) | 7.00% |
| 4-B(F)B(F,F)XB(F)B(F,F)-F(2-26) | 7.00% |
| 3-B(F)B(F,F)XB(F)B(F,F)-F(2-26) | 7.00% |
| 5-BB(F)B(F,F)XB(F)B(F,F)-F(2-37) | 5.00% |
| 5-GB(F)B(F,F)XB(F,F)-F(3-3) | 7.00% |
| 4-GB(F)B(F,F)XB(F,F)-F(3-3) | 7.00% |
| 3-GB(F)B(F,F)XB(F,F)-F(3-3) | 7.00% |
| 5-GB(F,F)XB(F)B(F,F)-F(3-8) | 3.00% |
| 4-GB(F,F)XB(F)B(F,F)-F(3-8) | 4.00% |
| 3-GB(F,F)XB(F)B(F,F)-F(3-8) | 5.00% |

NI = 107.5° C.;
Tc < −20° C.;
Δn = 0.198; and
Δ∈ = 132

Values of refractive index anisotropy and dielectric loss at 50 GHz of the liquid crystal composition 6 were as follows.

Refractive index anisotropy: 0.20

Dielectric loss: 0.017

### Example 7

Preparation and Physical Properties of Liquid Crystal Composition 7

| | |
|---|---|
| 3-BB(F)B(F,F)XB(F)-F(2-7) | 7.00% |
| 5-B(F)B(F,F)B(F,F)XB(F,F)-F(2-17) | 2.00% |
| 4-B(F)B(F,F)B(F,F)XB(F,F)-F(2-17) | 2.00% |
| 6-B(F)B(F,F)B(F,F)XB(F,F)-CF3(2-18) | 3.00% |
| 5-B(F)B(F,F)B(F,F)XB(F,F)-CF3(2-18) | 3.00% |
| 4-B(F)B(F,F)B(F,F)XB(F,F)-CF3(2-18) | 3.00% |
| 3-B(F)B(F,F)B(F,F)XB(F,F)-CF3(2-18) | 2.00% |
| 3-BB(F,F)XB(F)B(F,F)-F(2-23) | 10.00% |
| 5-B(F)B(F,F)XB(F)B(F,F)-F(2-26) | 8.00% |
| 4-B(F)B(F,F)XB(F)B(F,F)-F(2-26) | 8.00% |
| 3-B(F)B(F,F)XB(F)B(F,F)-F(2-26) | 8.00% |
| 5-BB(F)B(F,F)XB(F)B(F,F)-F(2-37) | 5.00% |
| 5-GB(F)B(F,F)XB(F,F)-F(3-3) | 7.00% |
| 4-GB(F)B(F,F)XB(F,F)-F(3-3) | 7.00% |
| 3-GB(F)B(F,F)XB(F,F)-F(3-3) | 7.00% |
| 5-GB(F,F)XB(F)B(F,F)-F(3-8) | 6.00% |
| 4-GB(F,F)XB(F)B(F,F)-F(3-8) | 6.00% |
| 3-GB(F,F)XB(F)B(F,F)-F(3-8) | 6.00% |

NI = 98.7° C.;
Tc < −20° C.;
Δn = 0.187; and
Δ∈ = 176

Values of refractive index anisotropy and dielectric loss at 50 GHz of the liquid crystal composition 5 were as follows.

Refractive index anisotropy: 0.21

Dielectric loss: 0.017

As described above, it is shown that that the liquid crystal composition of the disclosure is a material having excellent characteristic balance as a material for an element used for phase control of an electromagnetic wave signal having a frequency of 1 MHz to 400 THz.

The liquid crystal composition of the disclosure can be suitably used as a material for an element used for phase control of an electromagnetic wave signal having a frequency of 1 MHz to 400 THz.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A liquid crystal composition which is used for phase control of an electromagnetic wave signal having a frequency of 1 MHz to 400 THz, the liquid crystal composition comprising:
a compound selected from the group of compounds represented by Formula (1) as a liquid crystal compound, 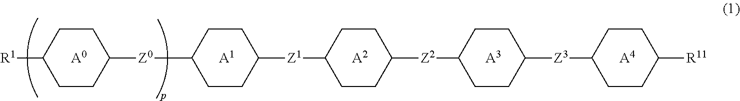
in Formula (1), the ring A⁰, the ring A¹, the ring A², the ring A³, and the ring A⁴ are each independently a group represented by any of Formulas (I) to (XIV);
Z⁰, Z¹, Z², and Z³ are each independently a single bond or —CF₂O—, where the number of —CF₂O— is one or less in Z⁰, Z¹, Z², and Z³;
p is 0 or 1;
R¹ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, where at least one —CH₂— in this R¹ may be replaced by —O—, —CO—, or —COO— such that O atoms are not directly bonded to each other; and
R¹¹ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, or —CN, —F, —Cl, —CF₃, —OCF₃, —CF₂H, —OCF₂H, —NCS, —SF₅, or —NO₂, where at least one —CH₂— in this R^{H} may be replaced by —O—, —CO—, or —COO— such that O atoms are not directly bonded to each other, and
in Formulas (VI) and (VII), R² is an alkyl having 1 to 5 carbon atoms, an alkoxy having 1 to 5 carbon atoms, an alkylthio having 1 to 5 carbon atoms, an alkenyl having 2 to 5 carbon atoms, or an alkenyloxy having 2 to 5 carbon atoms.

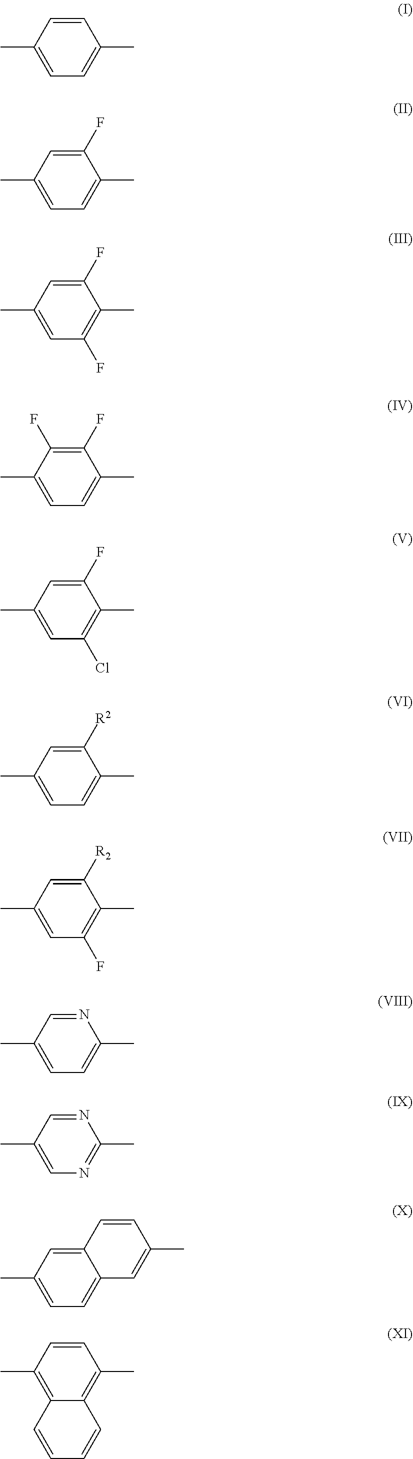

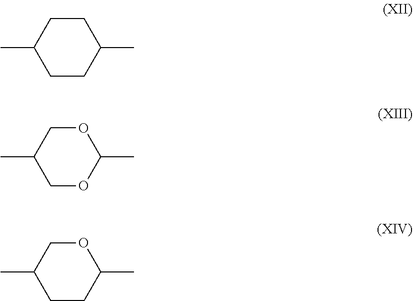

2. The liquid crystal composition according to claim 1, further comprising:
at least one compound selected from Formulas (2) and (3) as the compound represented by Formula (1), 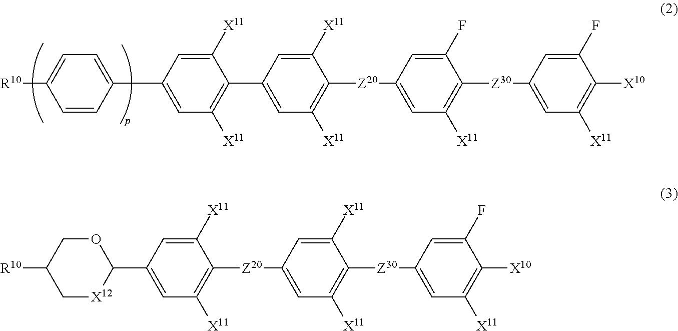
in Formulas (2) and (3),
one of Z²⁰ and Z³⁰ is a single bond and the other is —CF₂O—;
p is 0 or 1;
R¹⁰ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, where at least one —CH₂— in this R¹⁰ may be replaced by —O—, —CO—, or —COO— such that O atoms are not directly bonded to each other;
X¹⁰ is —CN, —F, —Cl, —CF₃, —OCF₃, —CF₂H, —OCF₂H, —NCS, —SF₅, or —NO₂;
X¹¹'s are each independently H or F; and
X¹² is —CH₂— or —O—.

3. The liquid crystal composition according to claim 2, further comprising:
at least one compound selected from the group of compounds represented by Formulas (2-1) to (2-41) and Formulas (3-1) to (3-13), 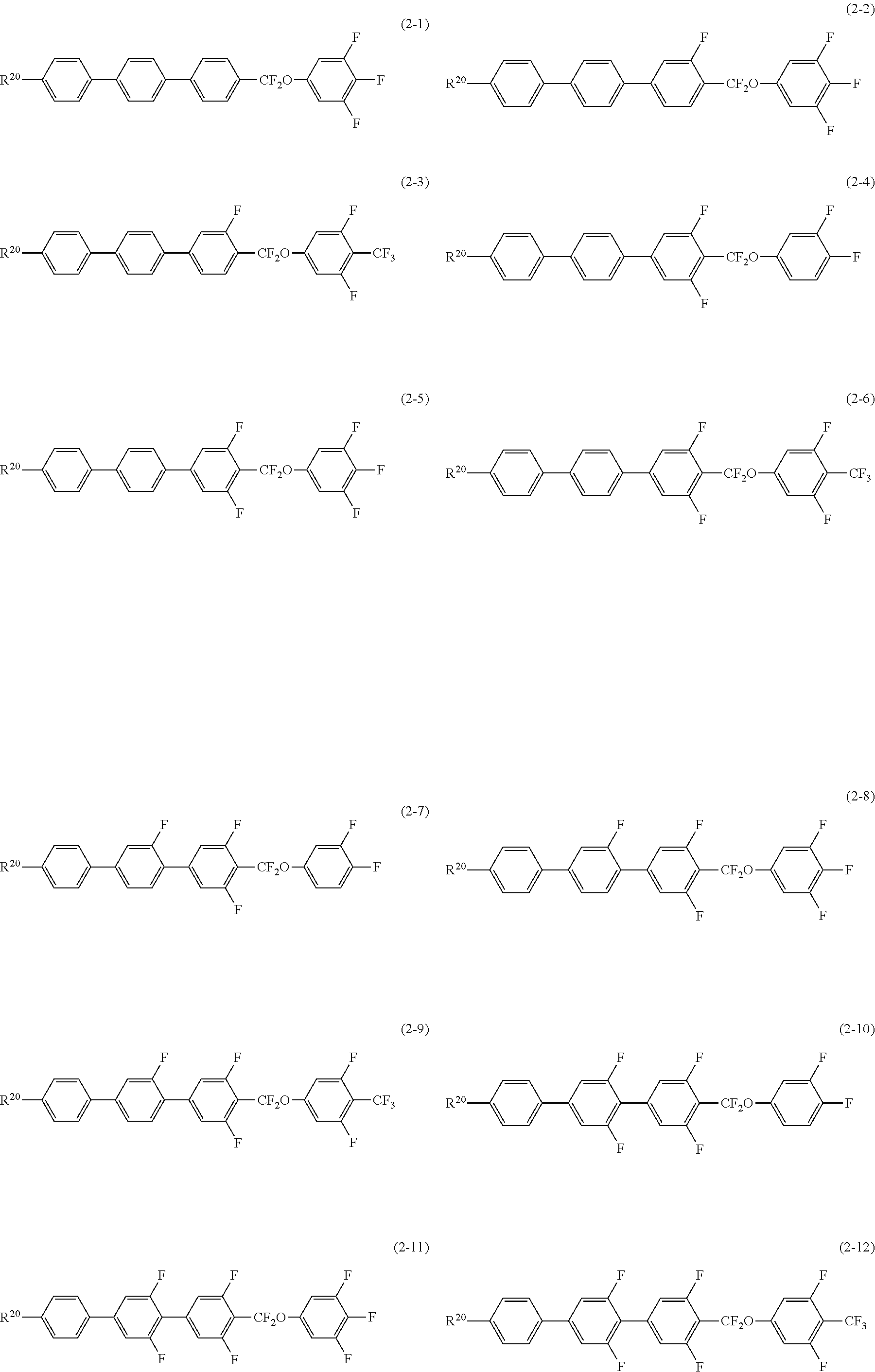 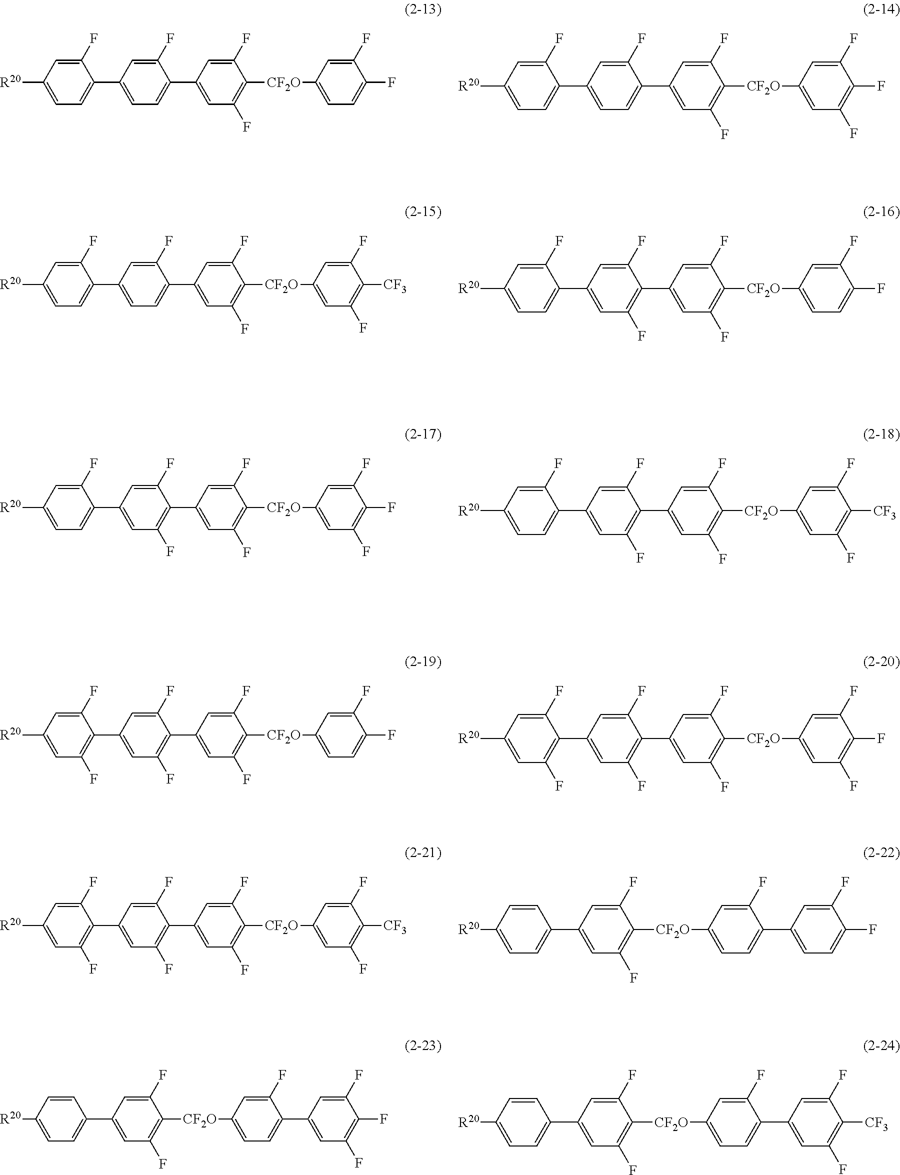 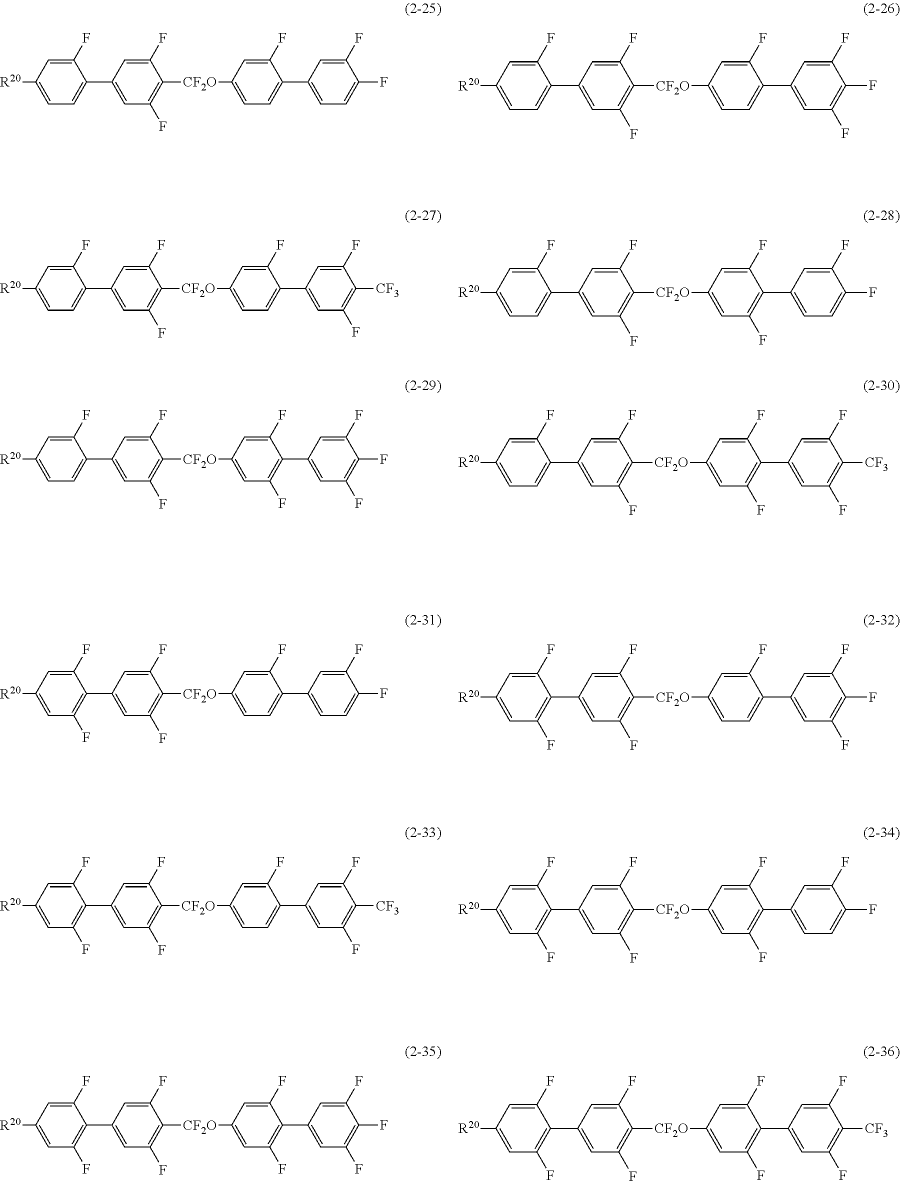 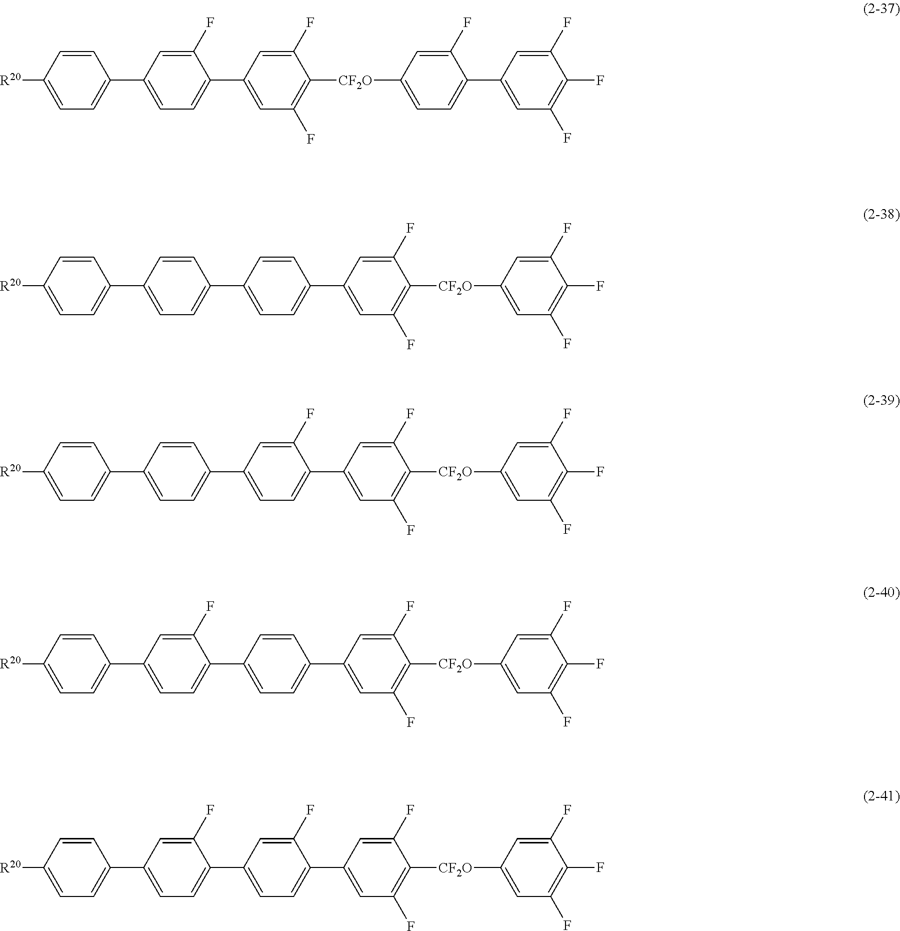 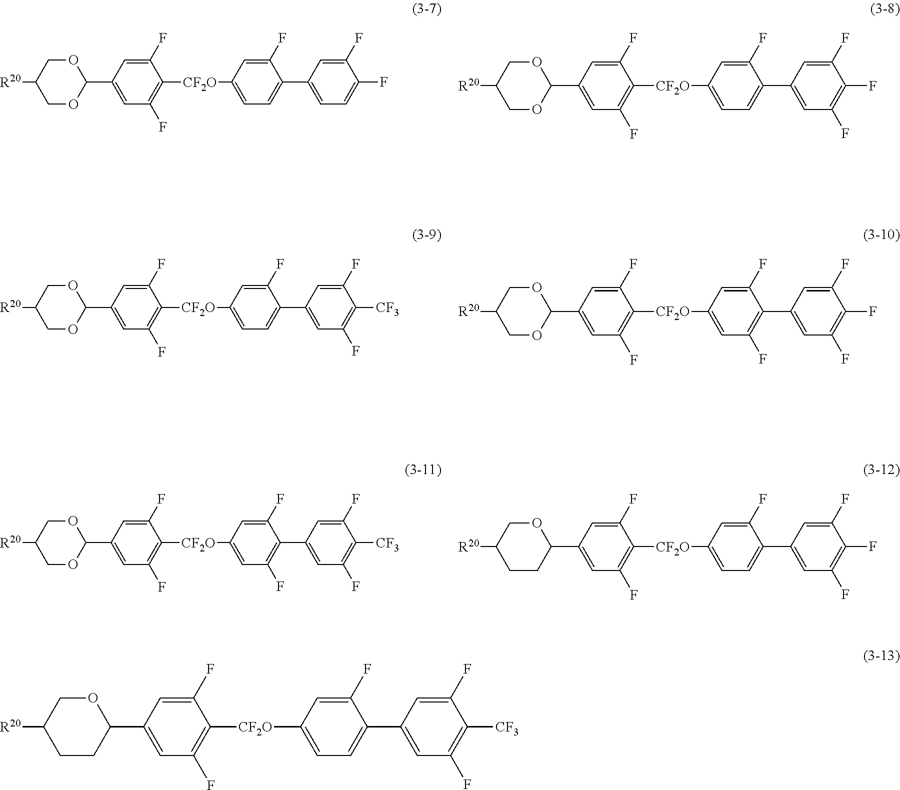
in Formulas (2-1) to (2-41) and Formulas (3-1) to (3-13),
R²⁰ is an alkyl having 1 to 8 carbon atoms, an alkoxy having 1 to 8 carbon atoms, an alkylthio having 1 to 8 carbon atoms, an alkenyl having 2 to 8 carbon atoms, or an alkenyloxy having 2 to 8 carbon atoms, where at least one —CH₂— in this R²⁰ may be replaced by —O— such that O atoms are not directly bonded to each other.

4. The liquid crystal composition according to claim 2, further comprising:
at least one compound selected from Formula (4) as the compound represented by Formula (1), 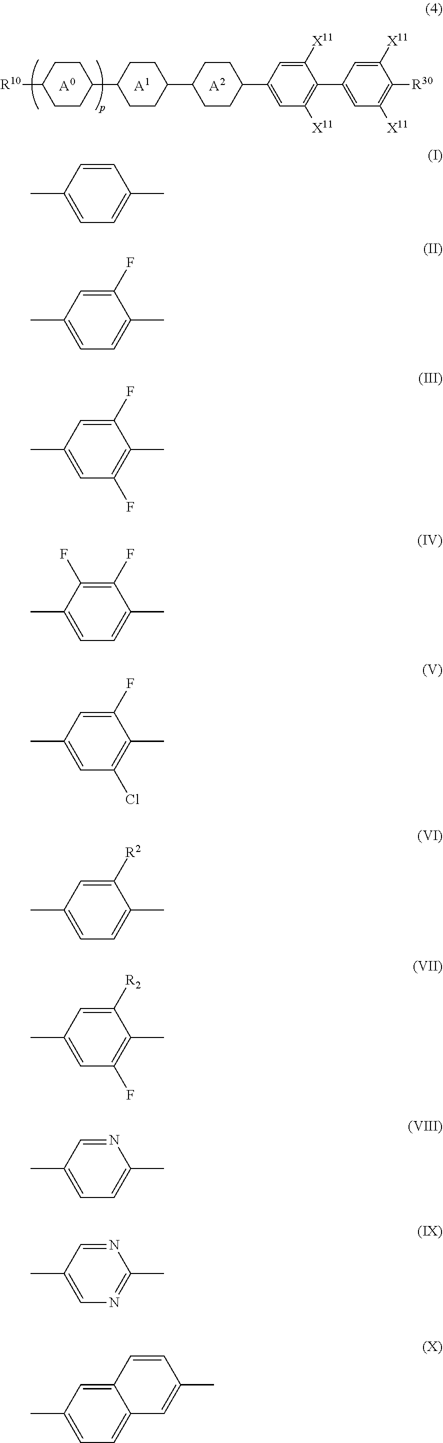 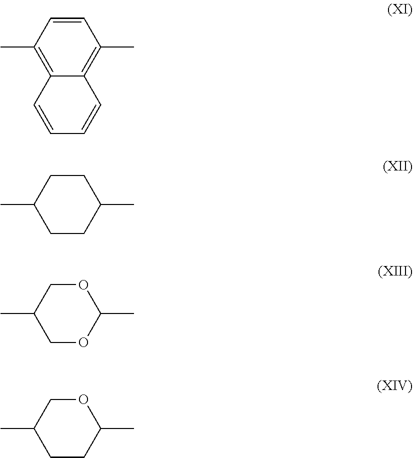
in Formula (4),
the ring A⁰, the ring A¹, and the ring A² are each independently a group represented by Formulas (I) to (XIV);
p is 0 or 1;
R¹⁰ is an alkyl having 1 to 12 carbon atoms, an alkoxy having 1 to 12 carbon atoms, an alkylthio having 1 to 12 carbon atoms, an alkenyl having 2 to 12 carbon atoms, or an alkenyloxy having 2 to 12 carbon atoms, where at least one —CH₂— in this R¹⁰ may be replaced by —O—, —CO—, or —COO— such that O atoms are not directly bonded to each other;
R³⁰ is R¹⁰, —CN, —F, —Cl, —CF₃, —OCF₃, —CF₂H, —OCF₂H, —NCS, —SF₅, or —NO₂, where respective R¹⁰'s may be the same as or different from each other in a case where R³⁰ is R¹⁰; and
X¹¹'s are each independently H or F, and
in Formulas (VI) and (VII), R² is an alkyl having 1 to 5 carbon atoms, an alkoxy having 1 to 5 carbon atoms, an alkylthio having 1 to 5 carbon atoms, an alkenyl having 2 to 5 carbon atoms, or an alkenyloxy having 2 to 5 carbon atoms.

5. The liquid crystal composition according to claim 1, further comprising at least one selected from a light stabilizer and an antioxidant.

6. The liquid crystal composition according to claim 1, further comprising an optically active compound.

7. The liquid crystal composition according to claim 1, further comprising a radically polymerizable monomer.

8. An element which is used for phase control of an electromagnetic wave signal having a frequency of 1 MHz to 400 THz, the element comprising:
the liquid crystal composition according to claim 1.
